(19) United States
(12) Patent Application Publication
(10) Pub. No.: US 2017/0240165 A1
(43) Pub. Date: Aug. 24, 2017

(54) VEHICLE DRIVE SYSTEM

(71) Applicant: TOYOTA JIDOSHA KABUSHIKI KAISHA, Toyota-shi (JP)

(72) Inventors: Kenta KUMAZAKI, Anjo-shi (JP); Kazuyuki SHIIBA, Miyoshi-shi (JP); Atsushi TABATA, Okazaki-shi (JP); Tatsuya IMAMURA, Okazaki-shi (JP); Koichi OKUDA, Toyota-shi (JP)

(73) Assignee: TOYOTA JIDOSHA KABUSHIKI KAISHA, Toyota-shi (JP)

(21) Appl. No.: 15/430,613

(22) Filed: Feb. 13, 2017

(30) Foreign Application Priority Data
Feb. 22, 2016 (JP) 2016-031515

(51) Int. Cl. B60W 20/40; B60K 6/442; B60W 10/12; B60W 10/06; B60W 10/115

(52) U.S. Cl. CPC B60W 20/40; B60W 10/06; B60W 10/115; B60W 10/12; B60K 6/442; B60W 2510/12; B60W 2510/1005; B60K 6/365

(57) ABSTRACT

Based on a determination result by a nitrogen concentration determination section, an electronic control unit changes a switching line used to switch between a differential state and a non-differential state of a differential mechanism and a gear shift line used to switch a gear stage of an automatic transmission mechanism. In conjunction with a change of an engine operation point to a high-speed side in a nitrogen-enriched state of intake air, a first motor rotational speed in the differential state of the differential mechanism becomes higher than that in a non-enriched state of the intake air. Thus, corresponding to the above, the differential mechanism is appropriately switched between the differential state and the non-differential state, and the gear stage of the automatic transmission mechanism is appropriately switched.

### INCORPORATION BY REFERENCE

The disclosure of Japanese Patent Application No. 2016-031515 filed on Feb. 22, 2016 including the specification, drawings and abstract is incorporated herein by reference in its entirety.

### BACKGROUND

1. Technical Field

The present disclosure relates to a technique of appropriately switching between a continuously variable transmission state and a stepped transmission state or selecting an appropriate gear stage in a vehicle drive system that increases nitrogen concentration of intake air of an internal combustion engine even when the intake air is in a nitrogen-enriched state.

2. Description of Related Art

A vehicle drive system includes an electric differential section that has: a differential mechanism that is coupled between the internal combustion engine and a drive wheel; a motor that is coupled to one of plural rotation elements in the differential mechanism; and an engagement device that selectively couples two of the plural rotation elements in the differential mechanism or selectively couples one of the rotation elements to a non-rotation member so as to bring the differential mechanism into a non-differential state. A controller of the vehicle drive system that includes a differential control section has been known, and the differential control section controls an engaging element that switches between a differential state and the non-differential state of the differential mechanism. For example, a controller of a vehicle drive system in Japanese Patent Application Publication No. 2010-76520 (JP 2010-76520 A) is such an example. The controller of the vehicle drive system in JP 2010-76520 A stores: a gear shift diagram that is based on a vehicle speed and output torque; and a switching diagram that is used to switch between the differential state and the non-differential state of the differential mechanism. Here, a switching line of the above differential mechanism has: a determination vehicle speed that segments a high-vehicle speed range where fuel economy is degraded when the vehicle drive system is brought into a continuously variable transmission state during a high-speed travel; and determination output torque that is set in accordance with a characteristic of a motor that can be arranged to generate, in order to downsize the motor by preventing a reaction torque of the motor from corresponding to a high-output range of the internal combustion engine (hereinafter also called simply as engine) during a high-output travel of a vehicle, a reduced amount of maximum output of electric energy from the motor for example. In a state where the electric differential section can differentiate the output, a rotational speed of a ring gear on an output side of the electric differential section is increased as the vehicle speed increases. In conjunction with this, a rotational speed of a sun gear, to which the motor is connected, is reduced. In the cases where the vehicle speed exceeds the above determination vehicle speed and a rotational speed of the motor is reduced to certain extent, just as described, electric efficiency is degraded. Thus, for example, by engaging the engaging element to fix the sun gear, the electric differential section is switched to the non-differential state where a gear ratio becomes constant and the electric differential section can no longer differentiate the output.

By the way, it has been known that the fuel economy can be improved and knocking of the engine can be reduced by using a gas separation membrane or the like to increase nitrogen concentration of the intake air of the engine, for example, and that NOx generation can be reduced by reducing a combustion temperature. When such a nitrogen-enriched engine is used, an optimum curve of the engine with consideration of the fuel economy and the like differs from that in a non-enriched state where the nitrogen concentration of the intake air is not increased. An operation point of the engine is changed in accordance with a change of the optimum curve. In the cases where the nitrogen-enriched engine is applied to the vehicle drive system in JP 2010-76520 A described above, the nitrogen concentration of the intake air of the engine is increased, and thus the optimum curve of the engine is shifted to a high-speed side, for example, an engine speed is increased, and, in conjunction with this, the rotational speed of the motor is also increased. At this time, if the vehicle drive system is controlled by using the switching diagram for the above non-enriched state regardless of the nitrogen concentration of the intake air, the differential mechanism is shifted from the differential state to the non-differential state in a state where the rotational speed of the motor is not reduced to a low rotational speed appropriate for engaging actuation of the engaging element. Consequently, a engagement shock possibly occurs to the actuated engaging element. In addition, in the cases where an automatic transmission is coupled to the electric differential section and the intake air is in a nitrogen-enriched state, an appropriate gear stage of the automatic transmission is not possibly selected in accordance with a travel state of the vehicle, such as the vehicle speed and requested drive power. In turn, such a problem occurs that, when the intake air is switched to the nitrogen-enriched state, the differential mechanism is not appropriately switched between the continuously variable transmission state and a stepped transmission state, or the gear stage of the automatic transmission is not appropriately switched.

### SUMMARY

In view of the above circumstance, the present disclosure provides a vehicle drive system capable of appropriately switching between a continuously variable transmission state and a stepped transmission state or selecting an appropriate gear stage in the vehicle drive system even when intake air is in a nitrogen-enriched state.

According to one perspective of the present disclosure, a vehicle drive system that includes a nitrogen concentration changing device, an electric differential section and an electronic control unit is provided. The nitrogen concentration changing device changes an amount of nitrogen contained in intake air of an internal combustion engine. The electric differential section includes a differential mechanism, a motor and an engaging element. The differential mechanism is coupled between the internal combustion engine and a drive wheel. The motor is coupled to one of plural rotation elements of the differential mechanism. The engaging element is configured to switch the differential mechanism to either one of a differential state and a non-differential state. The electronic control unit is configured to: (i) determine nitrogen concentration contained in the intake air to the internal combustion engine, (ii) change an operation point of the internal combustion engine based on a determination result of the nitrogen concentration, (iii) control the engaging element that switches the differential mechanism to either one of the differential state and the non-differential state, and (iv) change at least one of a vehicle speed threshold or a torque threshold that are used to switch between the differential state and the non-differential state of the differential mechanism based on the determination result of the nitrogen concentration.

According to the vehicle drive system as described above, the electronic control unit changes at least one of the vehicle speed threshold and the torque threshold that are used to switch between the differential state and the non-differential state of the differential mechanism based on the determination result of the nitrogen concentration. Thus, corresponding to a change of rotational speed of the motor compared to the non-enriched state of the intake air in conjunction with a change of an engine operation point, at least one of the vehicle speed threshold and the torque threshold that are used to switch between the differential state and the non-differential state of the differential mechanism is changed. In this way, in a nitrogen-enriched state of the intake air, the differential mechanism is appropriately switched between the differential state and the non-differential state.

In the vehicle drive system the electronic control unit may be configured to: (i) switch a gear stage of an automatic transmission mechanism that constitutes a part of a power transmission route, and (ii) change a gear shift line that is used to switch the gear stage of the automatic transmission mechanism based on the determination result of the nitrogen concentration.

According to the vehicle drive system as described above, the electronic control unit switches the gear stage of the automatic transmission mechanism constituting the part of the power transmission route, and changes the gear shift line that is used to switch the gear stage of the automatic transmission mechanism based on the determination result of the nitrogen concentration. Thus, corresponding to the rotational speed of the motor that is changed from that in the non-enriched state in conjunction with the change of the engine operation point, the gear shift line that is used to switch the gear stage of the automatic transmission mechanism is changed. In this way, in the nitrogen-enriched state of the intake air, the automatic transmission mechanism is automatically shifted to an appropriate gear stage.

In the vehicle drive system, the electronic control unit may be configured to set at least one of the vehicle speed threshold and the torque threshold, which are used to switch between the differential state and the non-differential state of the differential mechanism, or the gear shift line, which is used to switch a gear stage of an automatic transmission mechanism, such that a rotational speed of the motor becomes equal to or smaller than a specified value before and after a change of the operation point of the internal combustion engine.

According to the vehicle drive system as described above, at least one of the vehicle speed threshold and the torque threshold, which are used to switch between the differential state and the non-differential state of the differential mechanism, or the gear shift line, which is used to switch the gear stage of the automatic transmission mechanism, is set such that the rotational speed of the motor becomes at most equal to the specified value before and after the change of the operation point of the internal combustion engine. Thus, at least one of the vehicle speed threshold and the torque threshold, which are used to switch between the differential state and the non-differential state of the differential mechanism, or the gear shift line, which is used to switch the gear stage of the automatic transmission mechanism, is set such that the rotational speed of the motor becomes equal to or smaller than the specified value before and after the change of the operation point. In this way, the motor is prevented from falling out of an actuation enabling range thereof, and the motor can appropriately be actuated.

In the vehicle drive system, the electronic control unit may be configured to change at least one of the vehicle speed threshold and the torque threshold, which are used to switch between the differential state and the non-differential state of the differential mechanism, or change the gear shift line, which is used to switch a gear stage of an automatic transmission mechanism, when the electronic control unit determines that a time during which the nitrogen concentration becomes higher than a specified value or a time during which the nitrogen concentration becomes equal to or smaller than the specified value at least continues for a specified time.

According to the vehicle drive system as described above, at least one of the vehicle speed threshold and the torque threshold, which are used to switch between the differential state and the non-differential state of the differential mechanism, is changed, or the gear shift line, which is used to switch the gear stage of the automatic transmission mechanism, is changed when the time during which the nitrogen concentration becomes higher than the specified value or the time during which the nitrogen concentration becomes at most equal to the specified value at least continues for the specified time. Thus, even when switching between a state where the nitrogen concentration of the intake air exceeds the specified value and a state where the nitrogen concentration of the intake air falls below the specified value continues, a frequent change of at least one of the vehicle speed threshold and the torque threshold, which are used to switch between the differential state and the non-differential state of the differential mechanism, or a frequent change of the gear shift line, which is used to switch the gear stage of the automatic transmission mechanism, is suppressed. In this way, a driver is prevented from feeling uncomfortable due to frequent switching between the differential state and the non-differential state of the differential mechanism or frequent switching of the gear stage, which is caused by the above frequent change.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a skeletal view of a configuration of a vehicle drive system of a first embodiment of the present disclosure;

FIG. 2 is an actuation table that explains a relationship between gear shift actuation when the vehicle drive system in FIG. 1 is actuated for continuously variable transmission or stepped transmission and a combination of actuation of a hydraulic friction engagement device used therefor;

FIG. 3 is a collinear diagram that explains a correlative rotational speed of each gear stage when the vehicle drive system in FIG. 1 is actuated for stepped transmission;

FIG. 4 is a view that explains a supercharger and a nitrogen-enriching module provided in an engine of the vehicle drive system in FIG. 1;

FIG. 5 is a view that explains input/output signals of an electronic control unit provided in the vehicle drive system in FIG. 1;

FIG. 6 is a functional block diagram that explains a main section of a control function by the electronic control unit in FIG. 5;

FIG. 7 is a view that represents a gear shift diagram, a switching diagram, and a drive power source switching diagram of the vehicle drive system in FIG. 1 when intake air is in a non-enriched state;

FIG. 8 is a graph of one example of an optimum curve of the engine in the vehicle drive system in FIG. 1 and in which the optimum curve at a time of the non-enriched state where nitrogen concentration of the intake air suctioned to the engine is at most equal to specified concentration is represented by a solid line and the optimum curve at a time of a nitrogen-enriched state where the nitrogen concentration of the intake air suctioned to the engine is higher than the specified concentration is represented by a broken line;

FIG. 9 includes a switching diagram when an engine operation point that is used at a time when the intake air is in the nitrogen-enriched state is changed to a high-speed side of an engine operation point of a case where the intake air is in the non-enriched state in the vehicle drive system in FIG. 1, shows the switching diagram with the gear shift diagram and the drive power source switching diagram in the non-enriched state of the intake air, and corresponds to FIG. 7;

FIG. 10 includes a gear shift diagram of a case where the engine operation point in the nitrogen-enriched state of the intake air is changed to the high-speed side of the engine operation point in the non-enriched state of the intake air in the vehicle drive system in FIG. 1, shows the gear shift diagram with the switching diagram and the drive power source switching diagram in the non-enriched state of the intake air, and corresponds to FIG. 7;

FIG. 11 is a flowchart that explains a main section of control actuation of the electronic control unit in FIG. 5;

FIG. 12 is a flowchart that explains a main section of control actuation of the electronic control unit in FIG. 5;

FIG. 13 is a graph of one example of the optimum curve of the engine in a vehicle drive system of a second embodiment of the present disclosure, in which the optimum curve in the non-enriched state where the nitrogen concentration of the intake air suctioned to the engine is at most equal to the specified concentration is represented by a solid line and the optimum curve in the nitrogen-enriched state where the nitrogen concentration of the intake air suctioned to the engine is higher than the specified concentration is represented by a broken line;

FIG. 14 includes a switching diagram of a case where the engine operation point in the nitrogen-enriched state of the intake air is changed to a low-speed side of the engine operation point in the non-enriched state of the intake air in the vehicle drive system in FIG. 13, shows the switching diagram with the gear shift diagram and the drive power source switching diagram in the non-enriched state of the intake air, and corresponds to FIG. 7; and

FIG. 15 includes a gear shift diagram of the case where the engine operation point in the nitrogen-enriched state of the intake air is changed to the low-speed side of the engine operation point in the non-enriched state of the intake air in the vehicle drive system in FIG. 13, shows the gear shift diagram with the switching diagram and the drive power source switching diagram in the non-enriched state of the intake air, and corresponds to FIG. 7.

### DETAILED DESCRIPTION OF EMBODIMENTS

A detailed description will hereinafter be made on a vehicle drive system of the present disclosure with reference to the drawings.

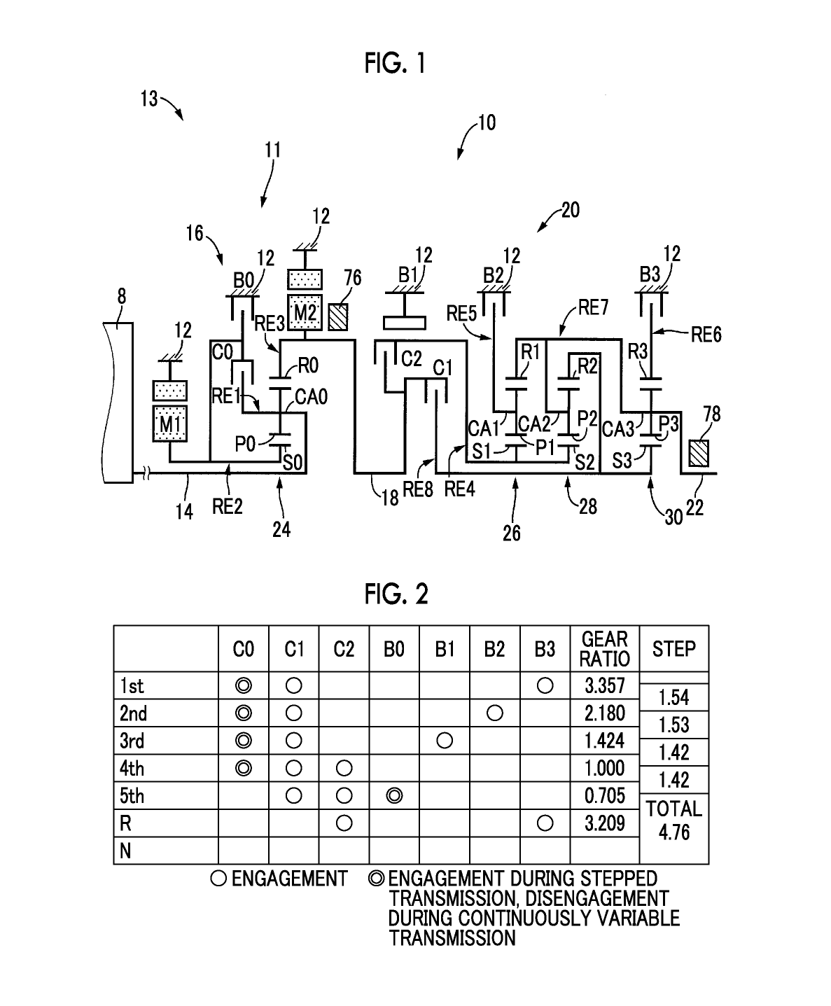

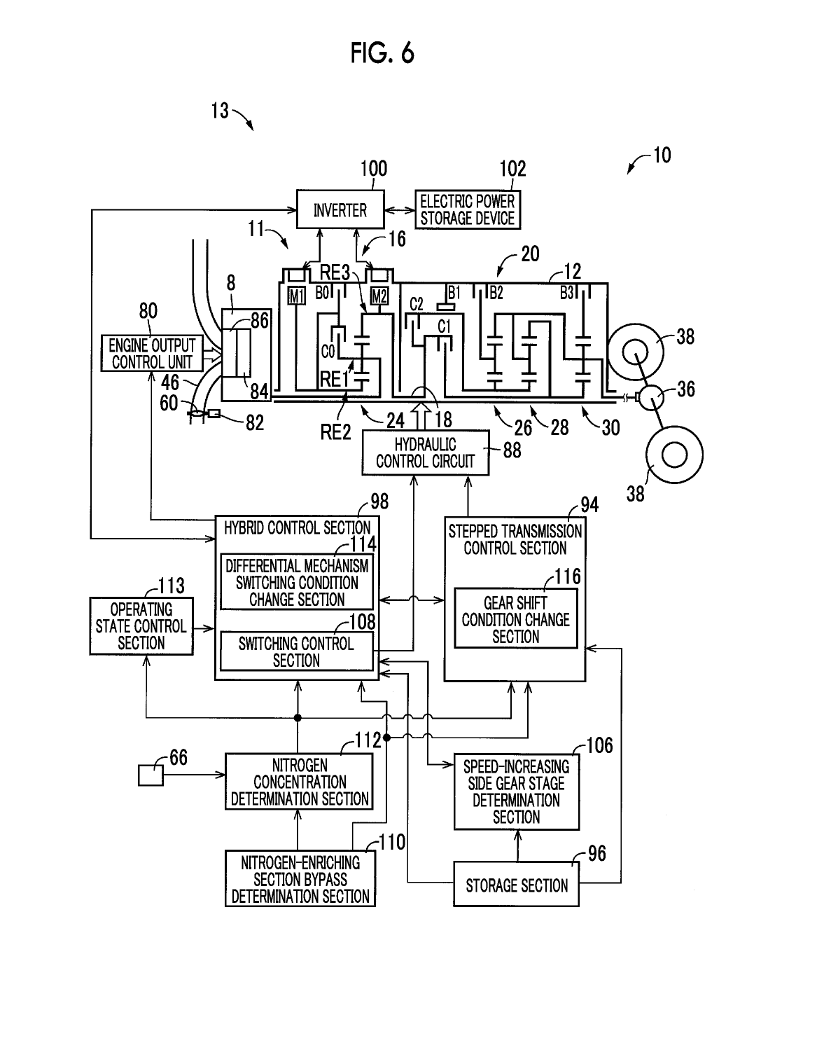

FIG. 1 is a skeletal view of a hybrid-vehicle drive system 13 (hereinafter described as a “drive system 13”) of a first embodiment of the present disclosure. In FIG. 1, the drive system 13 includes an engine (hereinafter also called simply as engine) 8 and a transmission mechanism 10. The transmission mechanism 10 includes an input shaft 14, a differential section 11, an automatic transmission mechanism 20, and an output shaft 22 in series. Here, the input shaft 14 is an input rotation member that is disposed on a common axis in a transmission case 12 (hereinafter referred to as a “case 12”) as a non-rotation member attached to a vehicle body. The differential section 11 is directly coupled to this input shaft 14 or is indirectly coupled thereto via a pulsation absorbing damper (a vibration damper), which is not shown. The automatic transmission mechanism 20 is coupled to the differential section 11 and a drive wheel 38 (see FIG. 6) in series via a transmission member (a transmission shaft) 18 in a power transmission route therebetween, and is a transmission section that functions as a stepped transmission. The output shaft 22 is an output rotation member that is coupled to this automatic transmission mechanism 20. This transmission mechanism 10 is favorably used in a front-engine, rear-wheel-drive (FR) vehicle, in which the transmission mechanism 10 is vertically disposed. The transmission mechanism 10 is provided between the engine 8 and a pair of the drive wheels 38 (see FIG. 6). The engine 8 is an internal combustion engine such as a gasoline engine or a diesel engine that serves as a travel drive power source, and is directly coupled to the input shaft 14 or is coupled thereto via the pulsation absorbing damper, which is not shown. The transmission mechanism 10 transmits power from the engine 8 to the right and left drive wheels 38 via a differential gear unit (a final reduction gear) 36 (see FIG. 6), a pair of axles, and the like, which constitute a part of the power transmission route, in sequence. Note that the transmission mechanism 10 is configured to be symmetrical about the axis thereof and a lower side thereof is not shown in the skeletal view in FIG. 1.

The differential section 11 can be said as an electric differential section due to a point that a differential state thereof is changed by using a first motor M1. The differential section 11 is a mechanical mechanism that is coupled to the first motor M1 and between the engine 8 and the drive wheel 38 and that mechanically distributes output of the engine 8 received by the input shaft 14. The differential section 11 includes: a differential mechanism 16 that distributes the output of the engine 8 to the first motor M1 and a transmission member 18; a second motor M2 that is provided in such a manner as to integrally rotate with the transmission member 18; and a switching clutch C0 and a switching brake B0 that bring the differential mechanism 16 into a non-differential state. Note that the first motor M1 and the second motor M2 are so-called motor generators that also have an electric power generating function. The first motor M1 at least has a generator (electric power generating) function so as to generate a reaction force. The second motor M2 at least has a motor function of outputting drive power as the travel drive power source, that is, a function as a travel motor. Each of the switching clutch C0 and the switching brake B0 is one example of the engaging element of the present disclosure.

The differential mechanism 16 includes, as a main component, a differential section planetary gear device 24 that is a single-pinion planetary gear set. This differential section planetary gear device 24 includes, as rotation elements (elements), a differential section sun gear S0, a differential section planetary gear P0, a differential section carrier CA0 that supports the differential section planetary gear P0 in such a manner as to allow rotation and revolution thereof, and a differential section ring gear R0 that meshes with the differential section sun gear S0 via the differential section planetary gear P0.

In this differential mechanism 16, the differential section carrier CA0 is coupled to the input shaft 14, that is, the engine 8. The differential section sun gear S0, which serves as one of the plural rotation elements of the differential mechanism 16, is coupled to the first motor M1. The differential section ring gear R0 is coupled to the transmission member 18. Meanwhile, the switching brake B0 is provided between the differential section sun gear S0 and the case 12. The switching clutch C0 is provided between the differential section sun gear S0 and the differential section carrier CA0. When those switching clutch C0 and switching brake B0 are disengaged, three elements of the differential section planetary gear device 24, which are the differential section sun gear S0, the differential section carrier CA0, and the differential section ring gear R0, can rotate relative to each other. In this way, the differential mechanism 16 is brought into the differential state where a differential action can be performed, that is, the differential action is exerted. Accordingly, the output of the engine 8 is distributed to the first motor M1 and the transmission member 18, and the first motor M1 generates electric energy by using some of the distributed output of the engine 8. The electric energy is stored and used to rotationally drive the second motor M2. Thus, the differential section 11 (the differential mechanism 16) functions as an electric differential device. For example, the differential section 11 is brought into a so-called continuously variable transmission state (an electric CVT state), and rotation of the transmission member 18 is continuously changed regardless of a specified speed of the engine 8.

When the switching clutch C0 or the switching brake B0 described above is engaged in this state, the differential mechanism 16 is brought into the non-differential state where the differential action is not performed, that is, that the differential action cannot be performed. More specifically, when the above switching clutch C0 is engaged, and the differential section sun gear S0 and the differential section carrier CA0 as two of the plural rotation elements of the differential section planetary gear device 24 are selectively coupled, the differential section sun gear S0, the differential section carrier CA0, and the differential section ring gear R0 as three rotation elements of the differential section planetary gear device 24 in the differential mechanism 16 rotate together, that is, are brought into an integrally rotating state, and the differential section 11 is also brought into the non-differential state. In addition, because a rotational speed of the transmission member 18 matches the speed of the engine 8 in this state, a gear ratio γ0 of the differential section 11 (the differential mechanism 16) is fixed to “1”. Next, when the switching brake B0 is engaged instead of the above switching clutch C0, the differential section sun gear S0 is brought into a non-rotating state in the differential mechanism 16. Thus, the differential mechanism 16 is brought into the non-differential state where the differential action cannot be performed. That is, the differential section 11 is also brought into the non-differential state. Meanwhile, because a rotational speed of the differential section ring gear R0 is increased to be higher than that of the differential section carrier CA0, the differential mechanism 16 functions as a speed increasing mechanism, and the differential section 11 (the differential mechanism 16) is brought into a constant gear shift state, that is, a stepped transmission state where the differential section 11 (the differential mechanism 16) functions as a speed increasing transmission.

The automatic transmission mechanism 20 includes a first planetary gear device 26 as a single-pinion planetary gear set, a second planetary gear device 28 as a single-pinion planetary gear set, and a third planetary gear device 30 as a single-pinion planetary gear set. The first planetary gear device 26 includes a first sun gear S1, a first planetary gear P1, a first carrier CA1 that supports the first planetary gear P1 in such a manner as to allow rotation and revolution thereof, and a first ring gear R1 that meshes with the first sun gear S1 via the first planetary gear P1. The second planetary gear device 28 includes a second sun gear S2, a second planetary gear P2, a second carrier CA2 that supports the second planetary gear P2 in such a manner as to allow rotation and revolution thereof, and a second ring gear R2 that meshes with the second sun gear S2 via the second planetary gear P2. The third planetary gear device 30 includes a third sun gear S3, a third planetary gear P3, a third carrier CA3 that supports the third planetary gear P3 in such a manner as to allow rotation and revolution thereof, and a third ring gear R3 that meshes with the third sun gear S3 via the third planetary gear P3.

In the automatic transmission mechanism 20, the first sun gear S1 and the second sun gear S2 are integrally coupled to each other, are selectively coupled to the transmission member 18 via a second clutch C2, and are selectively coupled to the case 12 via a first brake B1. The first carrier CA1 is selectively coupled to the case 12 via a second brake B2. The third ring gear R3 is selectively coupled to the case 12 via a third brake B3. The first ring gear R1, the second carrier CA2, and the third carrier CA3 are integrally coupled and are coupled to the output shaft 22. The second ring gear R2 and the third sun gear S3 are integrally coupled to each other and are selectively coupled to the transmission member 18 via a first clutch C1. When at least one of the first clutch C1 and the second clutch C2 is engaged, the above power transmission route is brought into a power transmission enabling state. Alternatively, when the first clutch C1 and the second clutch C2 are disengaged, the above power transmission route is brought into a power transmission blocking state.

The switching clutch C0, the first clutch C1, the second clutch C2, the switching brake B0, the first brake B1, the second brake B2, and the third brake B3, which function as the engaging elements, are hydraulic friction engagement devices that are widely used in a conventional stepped automatic transmission for a vehicle.

In the transmission mechanism 10 that is configured as described so far, as shown in an engagement actuation table in FIG. 2, for example, when the switching clutch C0, the first clutch C1, the second clutch C2, the switching brake B0, the first brake B1, the second brake B2, and the third brake B3 are selectively actuated for engagement, one of a first gear stage (a first gear shift stage) to a fifth gear stage (a fifth gear shift stage), a reverse gear stage (a reverse gear shift stage), or neutral is selectively established. In the transmission mechanism 10, when either one of the switching clutch C0 and the switching brake B0 is actuated for engagement, the differential section 11, which is in the constant gear shift state, and the automatic transmission mechanism 20 realize the stepped transmission state where the transmission mechanism 10 is actuated as a stepped transmission. In addition, in the transmission mechanism 10, when neither the switching clutch C0 nor the switching brake B0 is actuated for engagement, the differential section 11, which is in the continuously variable transmission state, and the automatic transmission mechanism 20 realize the continuously variable transmission state where the transmission mechanism 10 is actuated as an electric continuously variable transmission.

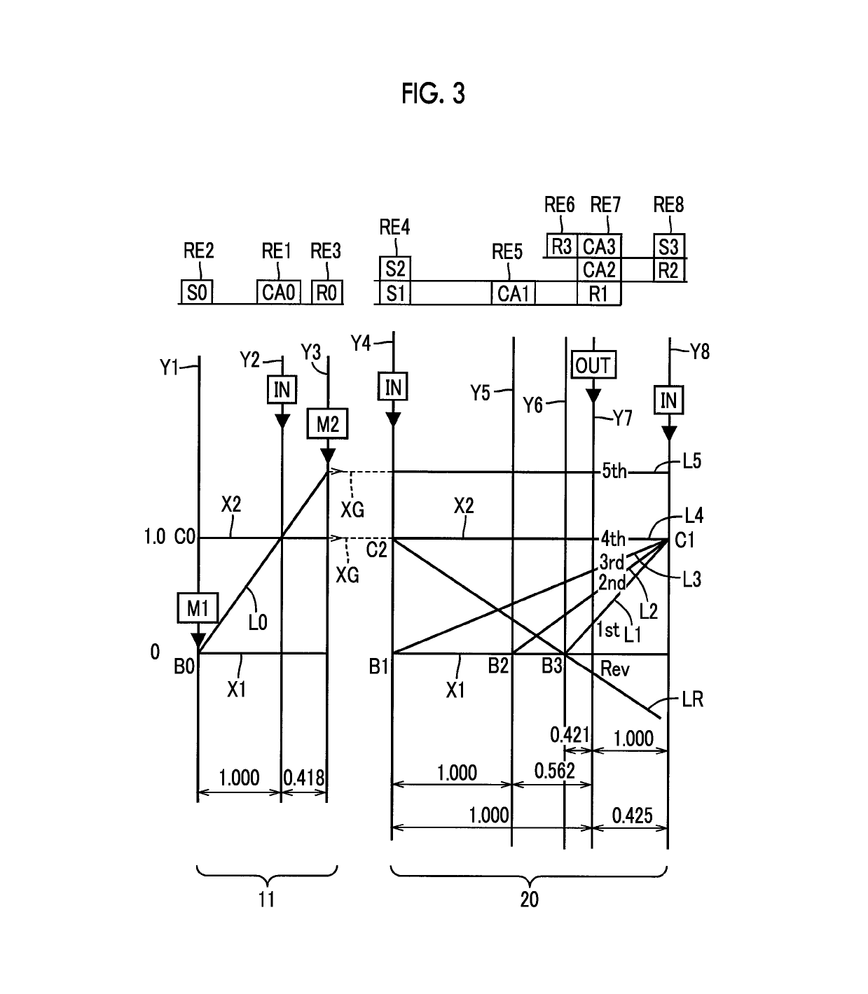

FIG. 3 is a collinear diagram in which a relative relationship among rotational speeds of the rotation elements, whose coupled states differ at every gear stage, in the transmission mechanism 10 can be represented by linear lines. The transmission mechanism 10 is configured by including: the differential section 11 that functions as a continuously variable transmission section or a first transmission section; and the automatic transmission mechanism 20 that functions as a stepped transmission section or a second transmission section. This collinear diagram in FIG. 3 is a two-dimensional coordinate that includes a horizontal axis representing a relationship at a gear ratio ρ among the planetary gear devices 24, 26, 28, 30 and a vertical axis representing a relative rotational speed. Of three horizontal lines, a lower horizontal line X1 represents a rotational speed of zero, an upper horizontal line X2 represents a rotational speed of “1.0”, that is, a speed Ne of the engine 8 that is coupled to the input shaft 14, and a horizontal line XG represents the rotational speed of the transmission member 18.

Three vertical lines Y1, Y2, Y3 correspond to the three elements of the differential mechanism 16 that constitutes the differential section 11. Sequentially from a left side, these vertical lines Y1, Y2, Y3 respectively represent relative rotational speeds of the differential section sun gear S0 that corresponds to a second rotation element (a second element) RE2, the differential section carrier CA0 that corresponds to a first rotation element (a first element) RE1, and the differential section ring gear R0 that corresponds to a third rotation element (a third element) RE3. An interval between two elements is defined in accordance with a gear ratio ρ0 of the differential section planetary gear device 24. Furthermore, sequentially from the left side, five vertical lines Y4, Y5, Y6, Y7, Y8 of the automatic transmission mechanism 20 respectively represent relative rotational speeds of: the first sun gear S1 and the second sun gear S2 that correspond to a fourth rotation element (a fourth element) RE4 and are coupled to each other; the first carrier CA1 that corresponds to a fifth rotation element (a fifth element) RE5; the third ring gear R3 that corresponds to a sixth rotation element (a sixth element) RE6; the first ring gear R1, the second carrier CA2, the third carrier CA3 that correspond to a seventh rotation element (a seventh element) RE7 and are coupled to each other; and the second ring gear R2 and the third sun gear S3 that correspond to an eighth rotation element (an eighth element) RE8 and are coupled to each other. Intervals between two elements are defined in accordance with gear ratios ρ1, ρ2, ρ3 of the first, second, and third planetary gear devices 26, 28, 30. In relationships among the vertical axes of the collinear diagram, when the interval between the sun gear and the carrier is set as an interval that corresponds to “1”, the interval between the carrier and the ring gear is set as an interval that corresponds to the gear ratio ρ of the planetary gear device.

In the automatic transmission mechanism 20, the fourth rotation element RE4 is selectively coupled to the transmission member 18 via the second clutch C2 and is selectively coupled to the case 12 via the first brake B1. The fifth rotation element RE5 is selectively coupled to the case 12 via the second brake B2. The sixth rotation element RE6 is selectively coupled to the case 12 via the third brake B3. The seventh rotation element RE7 is coupled to the output shaft 22. The eighth rotation element RE8 is selectively coupled to the transmission member 18 via the first clutch C1.

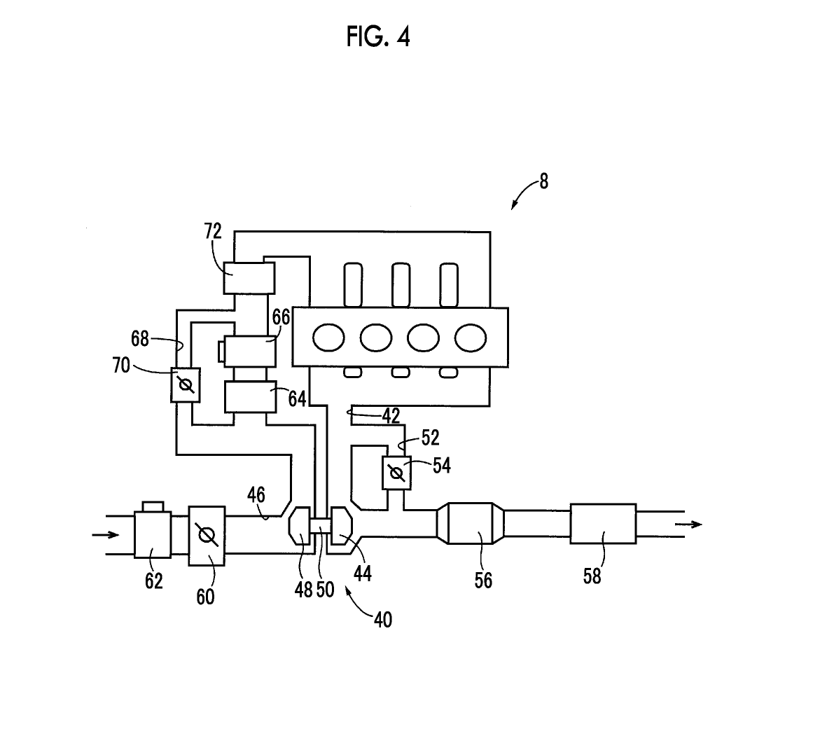

FIG. 4 is a view that explains intake and exhaust systems that are provided in the engine 8. The engine 8 is the internal combustion engine such as the diesel engine or the gasoline engine and includes a supercharger 40. The supercharger 40 is provided in the intake system of the engine 8 and is a known exhaust turbine supercharger, that is, a turbocharger that is rotationally driven by exhaust gas of the engine 8 and boosts intake air of the engine 8. More specifically, as shown in FIG. 4, the supercharger 40 includes an exhaust turbine wheel 44, an intake compressor wheel 48, and a rotational shaft 50. The exhaust turbine wheel 44 is provided in an exhaust passage 42 of the engine 8 and is rotationally driven by the exhaust gas of the engine 8. The intake compressor wheel 48 is provided in an intake passage 46 of the engine 8, is rotated by the exhaust turbine wheel 44, and thereby compresses the intake air of the engine 8. The rotational shaft 50 couples the exhaust turbine wheel 44 and the intake compressor wheel 48. When the exhaust gas of the engine 8 whose amount is sufficient to drive the supercharger 40 is delivered to the exhaust turbine wheel 44, the engine 8 is operated in a supercharged state where the engine 8 is supercharged by the supercharger 40. On the other hand, when the amount of the exhaust gas of the engine 8, which is delivered to the exhaust turbine wheel 44, is insufficient for drive of the supercharger 40, the supercharger 40 is hardly driven. At this time, the engine 8 is operated in a state where the engine 8 is hardly supercharged in comparison with the supercharged state, that is, in a natural intake state that is an intake state equivalent to that of a natural intake engine that does not include the supercharger 40.

An exhaust bypass route 52 and a waste gate valve 54 are provided. The exhaust bypass route 52 is provided in parallel with an exhaust route that is provided with the exhaust turbine wheel 44 in the exhaust passage 42. The waste gate valve 54 opens/closes the exhaust bypass route 52. In regard to the waste gate valve 54, an opening degree θwg of the waste gate valve 54 (hereinafter referred to as a waste gate valve opening degree θwg) can continuously be adjusted. An electronic control unit 74, which will be described below, controls an electric actuator, which is not shown. In this way, the electronic control unit 74 continuously opens/closes the waste gate valve 54 by using pressure in the intake passage 46. For example, as the waste gate valve opening degree θwg is increased, a larger amount of the exhaust gas of the engine 8 is discharged through the exhaust bypass route 52. Accordingly, in the supercharged state of the engine 8, air pressure PLin on a downstream side of the intake compressor wheel 48 in the intake passage 46, that is, supercharging pressure Pcmout (=PLin) of the supercharger 40 is lowered as the waste gate valve opening degree θwg is increased. That is, the waste gate valve 54 functions as a supercharging pressure adjustor that adjusts the supercharging pressure Pcmout. A start converter 56 is provided on a downstream side of a portion of the exhaust passage 42, to which the exhaust bypass route 52 on a downstream side of the waste gate valve 54 is connected. A post-processing device 58 is provided on a downstream side of the start converter 56 in the exhaust passage 42. The start converter 56 is a catalyst that is provided on an upstream side of the post-processing device 58 in terms of a flow of the exhaust gas and through which the exhaust gas at a higher temperature flows. The post-processing device 58 is a catalyst that is provided on the downstream side of the start converter 56. Note that, as it is generally known, the supercharging pressure Pcmout of the supercharger 40 is lowered as an opening degree θth of an electronic throttle valve 60, that is, a throttle opening degree θth is reduced in the supercharged state of the engine 8. The electronic throttle valve 60 is a valve mechanism that is provided on an upstream side of the intake compressor wheel 48 in the intake passage 46 of the engine 8 and adjusts an intake air amount of the engine 8. The electronic throttle valve 60 is actuated to be opened/closed by an electric throttle actuator 82 (shown in FIG. 6). An airflow meter 62 is provided on an upstream side of the electronic throttle valve 60 in the intake passage 46, and outputs a signal that corresponds to a flow rate of the air flowing through the intake passage 46. On a downstream side of the intake compressor wheel 48 in the intake passage 46, a nitrogen-enriching module 64, a nitrogen concentration sensor 66, an intake bypass route 68, and a bypass valve 70 are provided. The nitrogen-enriching module 64 functions as a nitrogen-enriching section that increases nitrogen concentration of the intake air that has been compressed by the supercharger 40. The nitrogen concentration sensor 66 measures nitrogen concentration Cn of the intake air that has passed through the nitrogen-enriching module 64. The intake bypass route 68 is disposed in parallel with an intake route that is provided with the nitrogen-enriching module 64 in the intake passage 46. The bypass valve 70 opens/closes the intake bypass route 68. An intercooler 72 as a heat exchanger is provided on a downstream side of a portion of the intake passage 46 to which the intake bypass route 68 on a downstream side of the bypass valve 70 is connected, and cools the intake air that is compressed by the supercharger 40. The intercooler 72 is a heat exchanger that exchanges heat between the intake air and ambient air or a coolant, so as to cool the intake air that has been compressed by the supercharger 40. In a state where the bypass valve 70 is closed, the intake air that flows through the nitrogen-enriching module 64 and whose nitrogen concentration Cn is thereby increased is delivered to the engine 8.

The nitrogen-enriching module 64 is configured by including plural polymeric hollow fiber membranes and an accommodating member that is made of a resin and accommodates a sheaf of the hollow fiber membranes. When the intake air that is compressed by the supercharger 40 is delivered to the nitrogen-enriching module 64, the nitrogen-enriching module 64 separates nitrogen, oxygen, and moisture due to a differences in membrane permeability of components in the intake air, and supplies the intake air whose nitrogen concentration Cn is increased to the downstream side in the intake passage 46 and to the engine 8. The moisture and oxygen that have permeated the membranes are discharged as permeable gas from the intake passage 46 at atmospheric pressure. The intake air with high nitrogen concentration Cn as impermeable gas that is less likely to permeate the membranes is delivered to the downstream side of the nitrogen-enriching module 64. Performance of the nitrogen-enriching module 64 depends on a temperature Tmn of the nitrogen-enriching module 64. As the temperature Tmn of the nitrogen-enriching module 64 is increased, an ability of increasing a ratio of an amount of nitrogen contained in the intake air (the nitrogen concentration Cn) is improved. The temperature Tmn of the nitrogen-enriching module 64 is changed by an environmental temperature, such as an ambient air temperature, an intake air temperature, or thermal conduction. In addition, as pressure of the intake air that is supplied to the nitrogen-enriching module 64, that is, the supercharging pressure Pcmout is increased, a larger amount of the compressed intake air is supplied to the nitrogen-enriching module 64. Thus, the amount of nitrogen separated by the nitrogen-enriching module 64 is increased, and the amount of nitrogen contained in the intake air is increased. Accordingly, as the temperature Tmn of the nitrogen-enriching module 64 is increased, and/or as the supercharging pressure Pcmout is increased, the nitrogen concentration Cn of the intake air of the engine 8 is increased. Note that the nitrogen concentration Cn of the intake air of the engine 8 is detected by the nitrogen concentration sensor 66.

As described above, when the nitrogen concentration Cn that is suctioned to the engine 8 is increased, NOx generation and knocking in the engine 8 are reduced. However, depending on a circumstance, the post-supercharged intake air flows through the intake bypass route 68. Thus, an increase in the nitrogen concentration Cn of the intake air that is suctioned to the engine 8 has to be suppressed. For this reason, the intake bypass route 68 is provided with the bypass valve 70 that functions as a nitrogen concentration changing device that changes the amount of nitrogen contained in the intake air of the engine 8. When the hollow fiber membranes are clogged, immediately after a start of the engine 8 at which it is desired not to increase the nitrogen concentration Cn of the intake air of the engine 8 in order to secure combustion stability, or the like, the intake air is not supplied by using the nitrogen-enriching module 64.

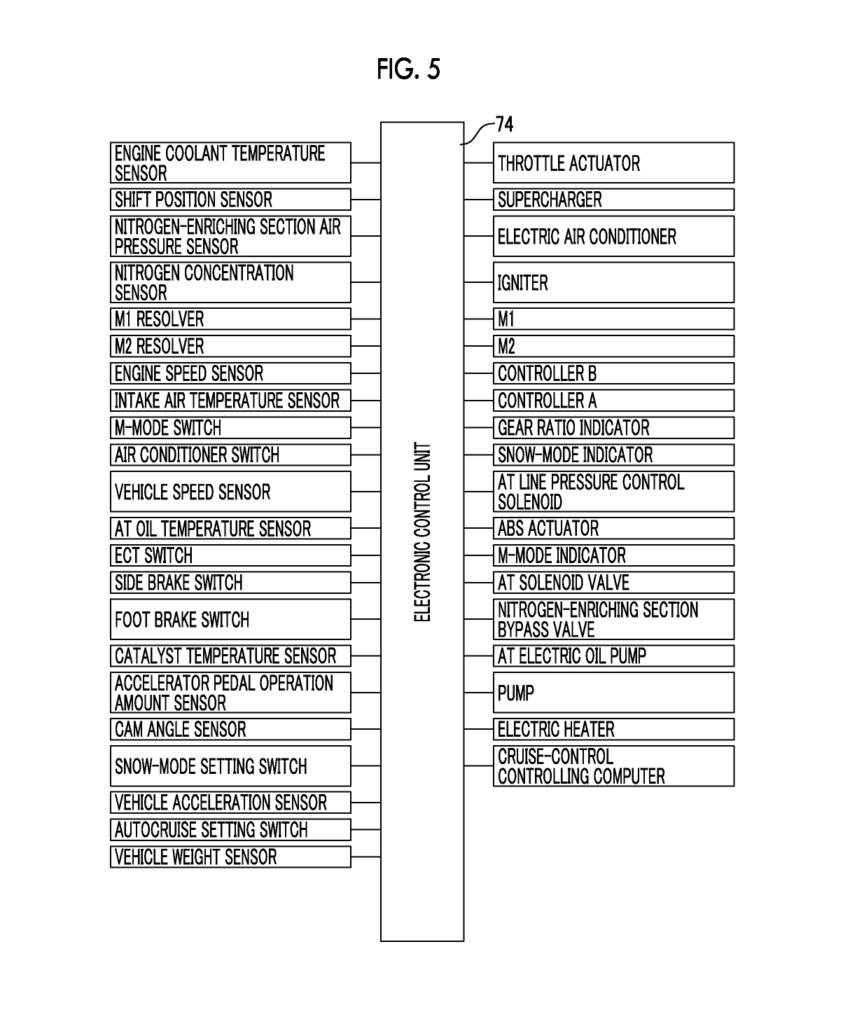

FIG. 5 exemplifies signals input to the electronic control unit 74 as a controller that controls the transmission mechanism 10 according to the present disclosure and signals output from the electronic control unit 74. This electronic control unit 74 is configured by including a so-called microcomputer that includes a CPU, a ROM, a RAM, an input/output interface, and the like. The electronic control unit 74 processes the signal in accordance with a program that is stored in the ROM in advance while using a temporary storage function of the RAM, and thereby executes drive control, such as hybrid drive control related to the engine 8, the first motor M1, and the second motor M2 and gear shift control of the automatic transmission mechanism 20.

From sensors, switches, and the like shown in FIG. 5, the electronic control unit 74 is supplied with: a signal indicative of pressure (atm) of the intake air delivered to the nitrogen-enriching module 64, the pressure being detected by a nitrogen-enriching section air pressure sensor; a signal indicative of the nitrogen concentration Cn (%) of the intake air on the downstream side of the nitrogen-enriching module 64 that is detected by the nitrogen concentration sensor 66; a signal indicative of a rotational speed Nm1 (rpm) of the first motor M1 (hereinafter referred to as a “first motor rotational speed Nm1”) that is detected by a rotational speed sensor such as a resolver and a rotational direction thereof; a signal indicative of a rotational speed Nm2 (rpm) of the second motor M2 (hereinafter referred to as a “second motor rotational speed Nm2”) that is detected by a rotational speed sensor 76 (FIG. 1) such as a resolver and a rotational direction thereof; a signal indicative of the engine speed Ne (rpm) as the speed of the engine 8; a signal indicative of a vehicle speed V (km/h) that corresponds to a rotational speed Nout (rpm) of the output shaft 22 and is detected by a vehicle speed sensor 78 (FIG. 1) as well as a travel direction of the vehicle; an accelerator pedal operation amount signal indicative of an operation amount of an accelerator pedal (an accelerator pedal operation amount) Acc (%) that corresponds to a requested output amount by a driver; and the like. Note that each of the above rotational speed sensor 76 and the above vehicle speed sensor 78 is a sensor that can detect not only the rotational speed but also the rotational direction. When the automatic transmission mechanism 20 is at a neutral position during a travel of the vehicle, the traveling direction of the vehicle is detected by the vehicle speed sensor 78.

The above electronic control unit 74 outputs: control signals to an engine output control unit 80 (see FIG. 6) that controls engine output, for example, a drive signal to the throttle actuator 82 that operates the opening degree θth of the electronic throttle valve 60 provided in the intake passage 46 of the engine 8, a fuel supply amount signal of controlling a fuel supply amount to each cylinder of the engine 8 by a fuel injector 84, an ignition signal that commands ignition timing of the engine 8 by an igniter 86; a supercharging pressure adjusting signal of commanding the supercharging pressure Pcmout in order to adjust a nitrogen content in the intake air for a purpose of improved fuel economy and the like, for example; a command signal of commanding actuation of the motors M1, M2; a valve command signal of actuating an electromagnetic valve included in a hydraulic control circuit 88 (see FIG. 6) in order to control hydraulic actuators of the hydraulic friction engagement devices in the differential section 11 and the automatic transmission mechanism 20; a drive signal to an actuator that controls an opening degree of the bypass valve 70, the bypass valve 70 adjusting the intake air amount flowing through the intake bypass route 68; a drive command signal of actuating electric hydraulic pump as a hydraulic supply of the hydraulic control circuit 88; and the like.

FIG. 6 is a functional block diagram that explains a main section of a control function by the electronic control unit 74. The electronic control unit 74 includes a stepped transmission control section 94, a storage section 96, a hybrid control section 98, a speed-increasing side gear stage determination section 106, a nitrogen-enriching section bypass determination section 110, a nitrogen concentration determination section 112, and an operating state control section 113. The stepped transmission control section 94 includes a gear shift condition change section 116. The hybrid control section 98 includes a switching control section 108 and a differential mechanism switching condition change section 114. Note that the stepped transmission control section 94 is one example of the automatic transmission mechanism control section of the present disclosure. The hybrid control section 98 is one example of the differential control section of the present disclosure. The electronic control unit 74 corresponds to the controller of the vehicle drive system of the present disclosure.

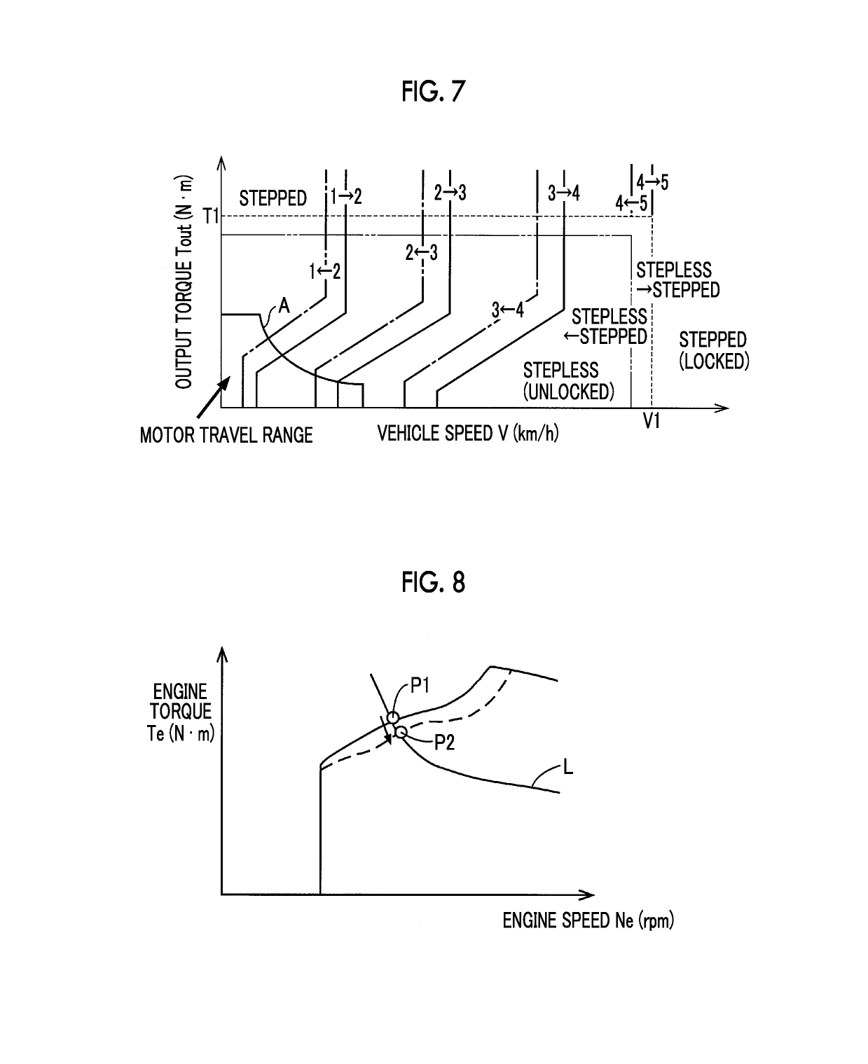

In FIG. 6, the stepped transmission control section 94 functions as gear shift control means that shifts a gear of the automatic transmission mechanism 20. For example, the stepped transmission control section 94 determines whether to shift the gear of the automatic transmission mechanism 20 based on a vehicle state that is indicated by the vehicle speed V and requested output torque Tout of the automatic transmission mechanism 20 from relationships (a gear shift diagram, a gear shift map) that are represented by solid lines and one-dot chain lines in FIG. 7 and are stored in the storage section 96 in advance. That is, the stepped transmission control section 94 determines a gear stage of the automatic transmission mechanism 20 that should be shifted and shifts the gear of the automatic transmission mechanism 20 so as to realize the determined gear stage. At this time, the stepped transmission control section 94 outputs a command (a gear shift output command) of engaging and/or disengaging the hydraulic friction engagement devices other than the switching clutch C0 and the switching brake B0 to the hydraulic control circuit 88, so as to realize the gear stage in accordance with the engagement table shown in FIG. 2, for example. Note that the gear shift diagram and a switching diagram shown in FIG. 7 are used to switch between the differential state and the non-differential state of the differential mechanism 16 and switch the gear stage of the automatic transmission mechanism 20 when the intake air of the engine 8 is in a non-enriched state, which will be described below.

The hybrid control section 98 optimally changes distribution of the drive power to the engine 8 and the second motor M2 and the reaction force that is generated by electric power generation of the first motor M1, so as to control the gear ratio γ0 of the differential section 11 as the electric continuously variable transmission, while actuating the engine 8 in an efficient actuation range at the continuously variable transmission state of the transmission mechanism 10, that is, in the differential state of the differential section 11. For example, the hybrid control section 98 computes target (requested) output of the vehicle from the accelerator pedal operation amount Acc and the vehicle speed V at a current traveling vehicle speed, the target (requested) output being a requested output amount by the driver. Then, the hybrid control section 98 computes total required target output from the target output and a requested charging value of the vehicle. In order to obtain the total target output, the hybrid control section 98 computes target engine output in consideration of transmission loss, an auxiliary machine load, assisted torque by the second motor M2, and the like. Then, the hybrid control section 98 controls the engine 8 so as to achieve the engine speed Ne and engine torque Te at which the target engine output is obtained, and controls an electric power generation amount of the first motor M1.

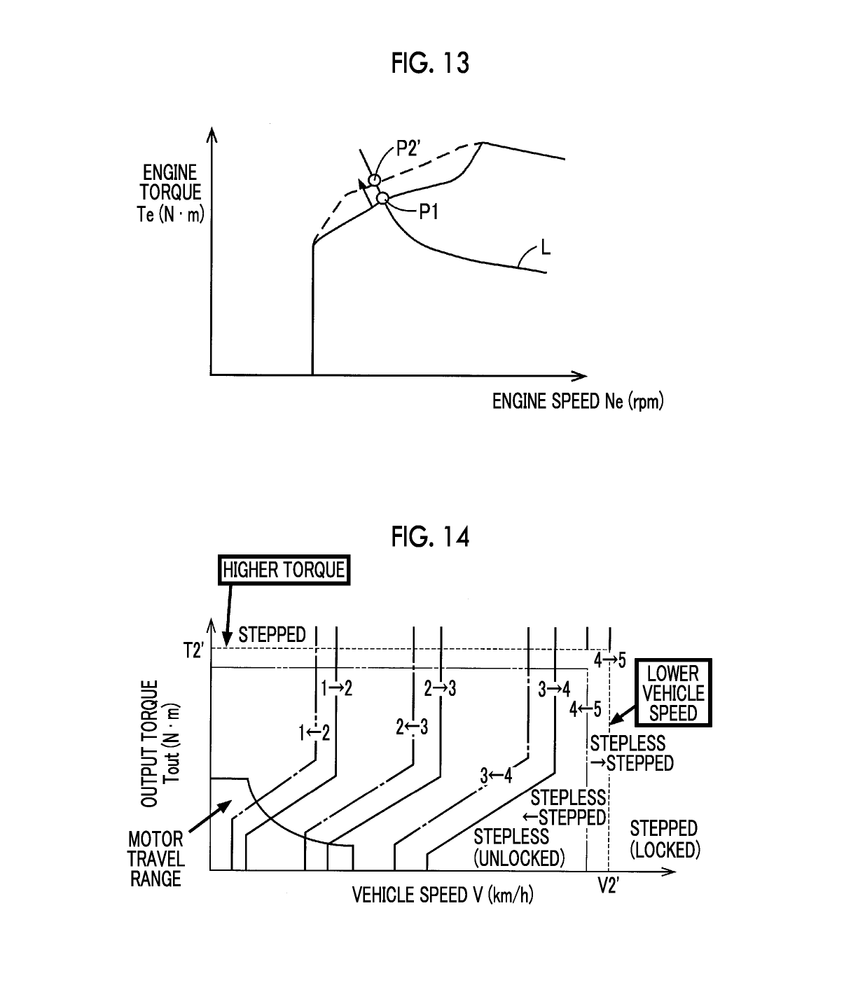

The hybrid control section 98 executes the control in consideration of the gear stage of the automatic transmission mechanism 20 for purposes of power performance, the improved fuel economy, and the like. In such hybrid control, in order to match the engine speed Ne, which is defined in order to actuate the engine 8 in the efficient actuation range, with the rotational speed of the transmission member 18, which is defined by the vehicle speed V and the gear stage of the automatic transmission mechanism 20, the differential section 11 functions as the electric continuously variable transmission. That is, the hybrid control section 98 stores an optimum curve (a fuel economy map, a relationship) of the engine 8 in advance, for example. The optimum curve is experimentally defined in advance so as to balance between an operation property and a fuel economy property during a continuously variable transmission travel in a two-dimensional coordinate that has the engine speed Ne and the output torque (the engine torque) Te of the engine 8 as parameters. In order to actuate the engine 8 along the optimum curve, the hybrid control section 98 defines a target value of a total gear ratio γT of the transmission mechanism 10 to obtain the engine torque Te and the engine speed Ne at which the engine output that is required to satisfy the target output (the total target output, the requested drive power) is generated, for example. Then, the hybrid control section 98 controls the gear ratio γ0 of the differential section 11 to realize the target value, and controls the total gear ratio γT within a change range in which the total gear ratio γT can be changed. The above optimum curve of the engine 8 is shown in FIG. 8 and FIG. 13, which will be described below.

A solid line A in FIG. 7 is a boundary line between an engine travel range and a motor travel range that is used to switch between a so-called engine travel and a so-called motor travel. The engine travel is a normal travel in which the vehicle starts/travels (hereinafter referred to as travel) with the engine 8 being a traveling drive power source . The motor travel is a motor travel in which the vehicle travels with the second motor M2 being the traveling drive power source. A relationship that has the boundary line (the solid line A) used to switch between the engine travel and the motor travel shown in this FIG. 7 and that is stored in advance is one example of a drive power source switching diagram (a drive power source map) that is configured as a two-dimensional coordinate that has the vehicle speed V and the output torque Tout being a drive power-related value as parameters. This drive power source switching diagram is stored with the gear shift diagram (the gear shift map) in the storage section 96 in advance, for example, the gear shift diagram (the gear shift map) being represented by a solid line and a one-dot chain line in the same FIG. 7.

The hybrid control section 98 determines whether a current travel range is the motor travel range or the engine travel range from the drive power source switching diagram in FIG. 7 based on the vehicle state indicated by the vehicle speed V and the requested output torque Tout, for example, and executes the motor travel or the engine travel. As described above, as it is apparent from FIG. 7, the motor travel by the hybrid control section 98 is executed at a time of the relatively low output torque Tout at which an engine efficiency is generally worse than that in a high torque range, that is, at a time of the low engine torque Te or at a time of the relatively low vehicle speed V, that is, in a low load range.

In order to switch between the engine travel and the motor travel, the hybrid control section 98 switches an actuation state of the engine 8 between an operation state and a stopped state. The hybrid control section 98 starts or stops the engine 8 when determining that the motor travel or the engine travel has to be switched from the drive power source switching diagram in FIG. 7, for example based on the vehicle state.

For example, in the cases where the accelerator pedal is depressed, the requested output torque Tout is thereby increased, and the vehicle state is changed from the motor travel range to the engine travel range, the hybrid control section 98 energizes the first motor M1 to increase the first motor rotational speed Nm1. In this way, the hybrid control section 98 starts the engine 8 such that the igniter 86 ignites at a specified engine speed Ne′, for example, the engine speed Ne at which autonomous rotation of the engine 8 is allowed, and thereby switches from the motor travel to the engine travel.

Meanwhile, in the cases where the accelerator pedal is no longer depressed, the requested output torque Tout is thereby reduced, and the vehicle state is changed from the engine travel range to the motor travel range, the hybrid control section 98 executes fuel cut by the fuel injector 84 to stop the engine 8, so as to switch from the engine travel to the motor travel. At this time, prior to the fuel cut, the hybrid control section 98 may reduce the first motor rotational speed Nm1 to reduce the engine speed Ne and stop the engine 8 such that the fuel is cut at the specified engine speed Ne′.

The hybrid control section 98 supplies the electric energy from the first motor M1 described above and/or electric energy from an electric power storage device 102 to the second motor M2 through an electric path even in the engine travel range. In this way, the hybrid control section 98 drives the second motor M2 to enable torque assist of assisting the power of the engine 8. Thus, the engine travel of this first embodiment includes the engine travel+the motor travel.

Regardless of a stopped state or a traveling state of the vehicle, the hybrid control section 98 can maintain the engine speed Ne at an arbitrary speed by controlling the first motor rotational speed Nm1 and/or the second motor rotational speed Nm2 by an electric CVT function of the differential section 11. For example, as it is understood from the colinear diagram in FIG. 3, when increasing the engine speed Ne, the hybrid control section 98 increases the first motor rotational speed Nm1 while maintaining the second motor rotational speed Nm2 that is restrained by the vehicle speed V to be substantially constant.

In order to determine whether to engage the switching clutch C0 or the switching brake B0 at a time when the transmission mechanism 10 is brought into the stepped transmission state, the speed-increasing side gear stage determination section 106 determines whether the gear stage to be shifted of the transmission mechanism 10 is a speed-increasing side gear stage, for example, a fifth gear stage based on the vehicle state in accordance with the gear shift diagram that is stored in the storage section 96 in advance and is shown in FIG. 7, for example.

By controlling switching between the engagement/disengagement of a differential state switching device (the switching clutch C0, the switching brake B0) based on the vehicle state, the switching control section 108 selectively switches between the continuously variable transmission state and the stepped transmission state, that is, between the differential state and the non-differential state. For example, the switching control section 108 determines whether it is currently in a stepless control range where the transmission mechanism 10 is brought into the continuously variable transmission state or a stepped control range where the transmission mechanism 10 is brought into the stepped transmission state based on the vehicle state indicated by the vehicle speed V and the requested output torque Tout from a relationship (a switching diagram, a switching map) that is represented by a broken line and a two-dot chain line in FIG. 7 and that is stored in the storage section 96 in advance. Based on this determination, the switching control section 108 switches the gear shift state so as to selectively switch the transmission mechanism 10 to the continuously variable transmission state or the stepped transmission state.

When determining that it is currently in the stepped control range, the switching control section 108 outputs a signal to disallow, that is, prohibit the hybrid control or continuously variable transmission control to the hybrid control section 98 and permits gear shifting of the stepped transmission control section 94 during stepped transmission that is set in advance. The stepped transmission control section 94 at this time executes automatic gear shifting of the automatic transmission mechanism 20 in accordance with the gear shift diagram that is stored in the storage section 96 in advance and is shown in FIG. 7, for example. For example, FIG. 2, which is stored in the storage section 96 in advance, shows combinations of the actuation of the hydraulic friction engagement devices, that is, C0, C1, C2, B0, B1, B2, B3, any one of which is selected during gear shifting at this time. In other words, the entire transmission mechanism 10, that is, the differential section 11 and the automatic transmission mechanism 20 function as a so-called stepped automatic transmission, and the gear stage is realized in accordance with the engagement table shown in FIG. 2.

On the other hand, when determining that it is currently in the stepless control range where the transmission mechanism 10 is switched to the continuously variable transmission state, the switching control section 108 outputs a command of disengaging the switching clutch C0 and the switching brake B0 to the hydraulic control circuit 88, so as to allow continuously variable transmission of the differential section 11 in the continuously variable transmission state and thereby realize the continuously variable transmission state as the entire the transmission mechanism 10. At the same time, the switching control section 108 outputs a signal of permitting the hybrid control to the hybrid control section 98 and also outputs a signal to the stepped transmission control section 94, the signal of fixing the current gear stage to the gear stage during continuously variable transmission that is set in advance or a signal of permitting automatic gear shifting of the automatic transmission mechanism 20 in accordance with the gear shift diagram that is stored in the storage section 96 in advance and is shown in FIG. 7, for example. In this case, the stepped transmission control section 94 executes automatic gear shifting through the actuation of the hydraulic friction engagement devices other than the engagement of the switching clutch C0 and the switching brake B0 in the engagement table in FIG. 2. As described above, the differential section 11, which is switched to the continuously variable transmission state by the switching control section 108, functions as a continuously variable transmission. Meanwhile, the automatic transmission mechanism 20 that is arranged in series functions as the stepped transmission. In this way, in regard to each gear stage of a first gear, a second gear, a third gear, and a fourth gear of the automatic transmission mechanism 20, the rotational speed that is input to the automatic transmission mechanism 20, that is, the rotational speed of the transmission member 18 is changed steplessly, the entire transmission mechanism 10 is thus brought into the continuously variable transmission state, and the total gear ratio γT can be realized steplessly.

FIG. 7 shows one example of the relationship (the gear shift diagram, the gear shift map) that serves as a base of a gear shifting determination of the automatic transmission mechanism 20 and is stored in the storage section 96 in advance, and is also one example of the gear shift diagram that is configured as the two-dimensional coordinate that has the vehicle speed V and the requested output torque Tout being the drive power-related value as the parameters. In FIG. 7, the solid lines are upshift lines, and the one-dot chain lines are downshift lines.

The broken line in FIG. 7 represents a determination vehicle speed V1 and determination output torque T1 that are used for the determination of the stepped control range and the stepless control range by the switching control section 108. That is, the broken line in FIG. 7 represents a high vehicle speed determination line and a high output travel determination line. The high vehicle speed determination line represents a series of the determination vehicle speed V1 as a high-speed travel determination value that is used to determine a high-speed travel of the hybrid vehicle and that is set in advance. The high output travel determination line is a series of the determination output torque T1 as a high-output travel determination value that is the drive power-related value of the drive power of the hybrid vehicle, that is used to determine a high-output travel during which the output torque Tout of the automatic transmission mechanism 20 becomes high, for example, and that is set in advance. Furthermore, as indicated by the two-dot chain line, a hysteresis that is used for the determination of the stepped control range and the stepless control range is provided for the broken line in FIG. 7. In other words, this FIG. 7 is the switching diagram (the switching map, the relationship) that is stored in advance and that is used to make a range determination of whether it is currently in the stepped control range or the stepless control range by the switching control section 108 and that has the vehicle speed V and the output torque Tout respectively including the determination vehicle speed V1 and the determination output torque T1 as the parameters. The determination vehicle speed V1 and the determination output torque T1 in this switching line are set in advance such that the first motor rotational speed Nm1 becomes at most equal to a first upper limit speed, at which the first motor M1 can be actuated within an output limit range, in the differential state of the differential mechanism 16 when the intake air, which will be described below, is in the non-enriched state. Note that this switching diagram may be stored as the gear shift map in the storage section 96 in advance. In addition, this switching diagram may include at least one of the determination vehicle speed V1 and the determination output torque T1, or may be a switching line that is stored in advance and has either one of the vehicle speed V and the output torque Tout as the parameter.

By the way, when the nitrogen concentration Cn of the intake air that is suctioned to the engine 8 is increased, a characteristic of the engine 8 is changed. In such a case, for example, switching between the continuously variable transmission state and the stepped transmission state of the drive system 13 or switching of the gear stage of the automatic transmission mechanism 20 may not appropriately be executed in accordance with a travel state of the vehicle such as the vehicle speed V and the requested drive power Tout. Thus, when the nitrogen concentration Cn of the intake air is increased, control of changing the switching line and the gear shift line shown in FIG. 7 is executed. A description will hereinafter be made on control actuation.

The nitrogen-enriching section bypass determination section 110 determines whether the bypass valve 70 is opened and the intake air flows through the intake bypass route 68 and thus bypasses the nitrogen-enriching module 64. Based on a fact that a command of opening the bypass valve 70 is sent from the electronic control unit 74 to an actuator that drives the bypass valve 70 when the hollow fiber membranes of the nitrogen-enriching module 64 are clogged, immediately after the start of the engine 8, or the like in order to secure the combustion stability, the nitrogen-enriching section bypass determination section 110 determines that the bypass valve 70 is opened and that the intake air bypasses the nitrogen-enriching module 64.

When the nitrogen-enriching section bypass determination section 110 determines that the intake air does not bypass the nitrogen-enriching module 64, the nitrogen concentration determination section 112 determines the nitrogen concentration Cn contained in the intake air to the engine 8 based on whether the nitrogen concentration Cn of the intake air of the engine 8 detected by the nitrogen concentration sensor 66 exceeds specified concentration Cn0 that is experimentally set in advance. When the nitrogen concentration Cn of the intake air is higher than the specified concentration Cn0, the nitrogen concentration determination section 112 determines that the intake air is in a nitrogen-enriched state. When the nitrogen concentration Cn of the intake air is at most equal to the specified concentration Cn0, the nitrogen concentration determination section 112 determines that the intake air is in the non-enriched state. The nitrogen concentration determination section 112 supplies a signal indicative of whether the intake air is in the nitrogen-enriched state or the non-enriched state to the operating state control section 113, the hybrid control section 98, and the stepped transmission control section 94. Here, the above specified concentration Cn0 is a threshold that is used to determine whether the intake air is in the nitrogen-enriched state or the non-enriched state. In addition, the nitrogen concentration determination section 112 determines whether the intake air is switched from the non-enriched state where the nitrogen concentration Cn is at most equal to the specified concentration Cn0 to the nitrogen-enriched state where the nitrogen concentration Cn is higher than the specified concentration Cn0 and the nitrogen-enriched state at least continues for a specified time after the intake air is switched to the nitrogen-enriched state where the nitrogen concentration Cn is higher than the specified concentration Cn0. Furthermore, the nitrogen concentration determination section 112 determines whether the intake air is switched from the nitrogen-enriched state where the nitrogen concentration Cn is higher than the specified concentration Cn0 to the non-enriched state where the nitrogen concentration Cn is at most equal to the specified concentration Cn0 and the non-enriched state at least continues for the specified time after the intake air is switched to the non-enriched state where the nitrogen concentration Cn is at most equal to the specified concentration Cn0. When determining that the nitrogen-enriched state at least continues for the specified time after the intake air is switched from the non-enriched state to the nitrogen-enriched state, or when determining that the non-enriched state at least continues for the specified time after the intake air is switched from the nitrogen-enriched state to the non-enriched state, the nitrogen concentration determination section 112 supplies a continuation signal indicative of the determination result to the hybrid control section 98 and the stepped transmission control section 94. The above specified time is a minimum time during which the driver is suppressed from feeling uncomfortable due to switching between the differential state and the non-differential state of the differential mechanism 16 and switching of the gear stage of the automatic transmission mechanism 20 based on a change even when the change is made in the determination vehicle speed and the determination torque that are used to switch between the differential state and the non-differential state of the differential mechanism 16 or the gear shift line that is used to switch the gear stage of the automatic transmission mechanism 20 every time the specified time elapses. The above specified time is experimentally defined in advance.

The operating state control section 113 changes an operation point of the engine 8 based on the determination result of the nitrogen concentration determination section 112. FIG. 8 is a graph of one example of the optimum curve (an engine minimum fuel consumption rate characteristic) of the engine 8 that is represented by a relationship between the engine speed Ne and the engine torque Te of the engine 8. The optimum curve at a time of the non-enriched state where the nitrogen concentration Cn of the intake air suctioned to the engine 8 is at most equal to the specified concentration Cn0 is represented by a solid line. The optimum curve at a time of the nitrogen-enriched state where the nitrogen concentration Cn of the intake air suctioned to the engine 8 is higher than the specified concentration Cn0 is represented by a broken line. The operating state control section 113 selects the optimum curve represented by the solid line at the time of the non-enriched state where the nitrogen concentration Cn of the intake air is at most equal to the specified concentration Cn0, and selects the optimum curve represented by the broken line at the time of the nitrogen-enriched state where the nitrogen concentration Cn of the intake air is higher than the specified concentration Cn0. In a portion of the optimum curve at the time when the intake air is in the nitrogen-enriched state, the engine speed Ne is shifted to a high-speed side and the engine torque Te is shifted to a low-torque side of those on the optimum curve at the time when the intake air is in the non-enriched state. From the engine optimum curve that is selected based on the determination result of the nitrogen concentration determination section 112, that is, based on whether the intake air is in the non-enriched state or the nitrogen-enriched state, the operating state control section 113 changes the engine operation point on the engine optimum curve before switching to be located on the selected engine optimum curve after switching based on the engine output that is required to satisfy the target output (the total target output, the requested drive power), for example. For example, when the engine output at the time when the intake air of the engine 8 is changed from the non-enriched state to the nitrogen-enriched state is not changed from the specified engine output, the operating state control section 113 changes the operation point of the engine 8 from an operation point P1 on the engine optimum curve in the non-enriched state to an operation point P2 on the engine optimum curve in the nitrogen-enriched state in an arrow direction on a specified equal output curve L of the engine 8. At the operation point P2 of the engine 8 in the nitrogen-enriched state of the intake air, the engine speed Ne is on the high-speed side and the engine torque Te is on the low-torque side of the operation point P1 of the engine 8 in the non-enriched state of the intake air at the specified engine output. The operating state control section 113 outputs a command to the hybrid control section 98 such that the engine 8 is actuated at the engine operation point P2, to which the engine operation point is changed based on the determination result of the nitrogen concentration determination section 112, in the nitrogen-enriched state of the intake air in the differential state of the differential mechanism 16. In this way, the operating state control section 113 controls the operation states of the engine 8, the first motor M1, and the second motor M2.

In the nitrogen-enriched state of the intake air, the operation point P1 of the engine 8 is changed to the operation point P2 at which the engine speed Ne is located on the high-speed side. Thus, when the differential mechanism 16 is in the differential state, the first motor rotational speed Nm1 of the first motor M1 that is coupled to the differential section sun gear S0 becomes higher than the first motor rotational speed Nm1 at the time when the intake air of the engine 8 is in the non-enriched state. For this reason, in the nitrogen-enriched state of the intake air of the engine 8, the continuously variable transmission state (the differential state) at a fourth gear stage is switched to the stepped transmission state (the non-differential state) based on a fact that the vehicle speed V exceeds the determination vehicle speed V1 in the above switching diagram in FIG. 7, which is used when the intake air of the engine 8 is in the non-enriched state. In such a case, the first motor rotational speed Nm1 during switching is higher than a second upper limit speed within a range where an increase in an engagement shock during the engagement of the switching brake B0 is suppressed. Thus, the engagement shock that occurs during the engagement of the switching brake B0 for establishing the fifth gear stage is possibly increased. Here, the second upper limit speed is an extremely low rotational speed and is set to be lower than the first upper limit speed. In addition, in the nitrogen-enriched state of the intake air of the engine 8, the differential mechanism 16 is switched from the differential state to the non-differential state based on a fact that the output torque Tout exceeds the determination torque T1 in the above switching diagram in FIG. 7 that is used when the intake air of the engine 8 is in the non-enriched state. In such a case, the first motor M1 possibly exceeds an output limit that is defined by constant rating or the like set in advance during the high-output travel of the vehicle.

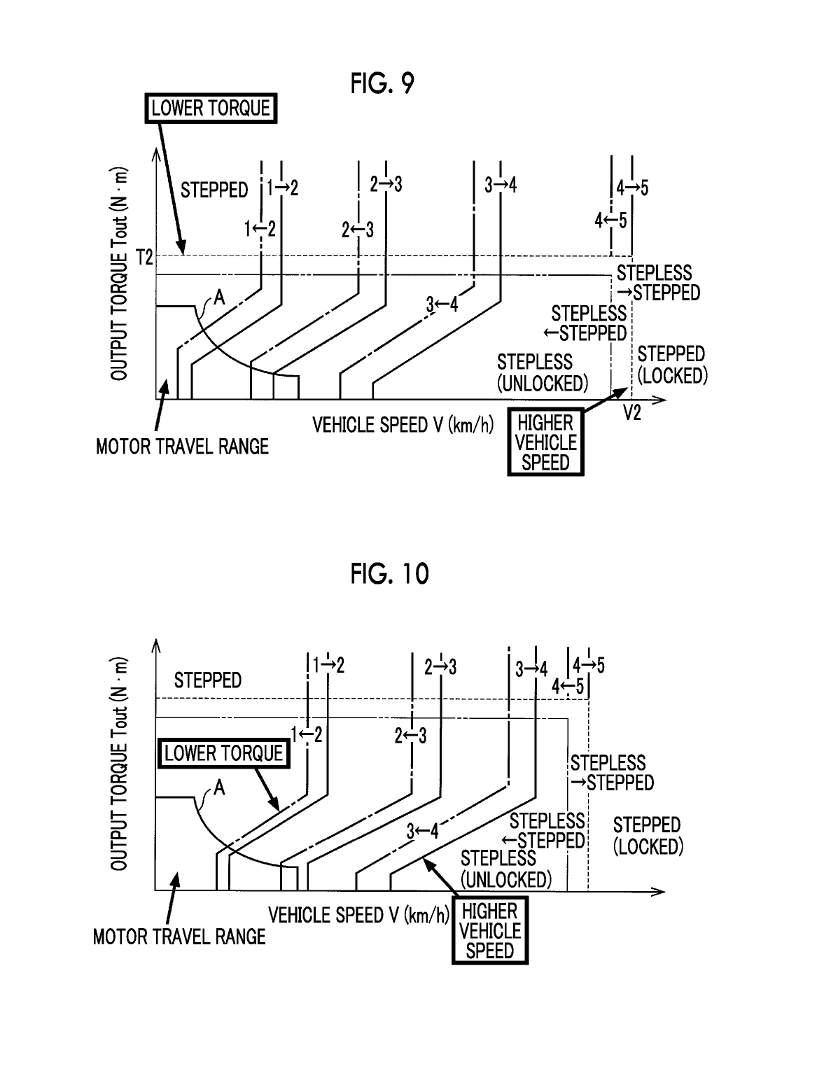

The differential mechanism switching condition change section 114 of the hybrid control section 98 changes the vehicle speed V and the output torque Tout based on the determination result of the nitrogen concentration determination section 112, so as to switch between the differential state and the non-differential state of the differential mechanism 16. FIG. 9 is one example of a switching diagram when, when the intake air is in the nitrogen-enriched state, the engine operation point P2 is changed to the high-speed side of the engine operation point P1 of the case where the intake air is in the non-enriched state, shows the one example of the switching diagram with the one example of the gear shift diagram and the one example of the drive power source switching diagram in the non-enriched state of the intake air, and corresponds to FIG. 7. when the nitrogen-enriching section bypass determination section 110 denies that the intake air bypasses the nitrogen-enriching module 64 and determines that the intake air is switched from the non-enriched state to the nitrogen-enriched state and that the nitrogen-enriched state at least continues for a specified time since switching from the non-enriched state to the nitrogen-enriched state, the differential mechanism switching condition change section 114 changes the determination vehicle speed V1 (shown in FIG. 7) to a determination vehicle speed V2 (shown in FIG. 9). At the determination vehicle speed V1, the differential mechanism 16 is switched between the differential state and the non-differential state in the non-enriched state of the intake air. At the determination vehicle speed V2, the differential mechanism 16 is switched between the differential state and the non-differential state in the nitrogen-enriched state of the intake air. In addition, when the nitrogen-enriching section bypass determination section 110 denies that the intake air bypasses the nitrogen-enriching module 64 and determines that the intake air is switched from the non-enriched state to the nitrogen-enriched state and that the nitrogen-enriched state at least continues for the specified time since switching from the non-enriched state to the nitrogen-enriched state, the differential mechanism switching condition change section 114 changes the determination torque T1 (shown in FIG. 7) to determination torque T2 (shown in FIG. 9). At the determination torque T1, the differential mechanism 16 is switched between the differential state and the non-differential state in the non-enriched state of the intake air. At the determination torque T2, the differential mechanism 16 is switched between the differential state and the non-differential state in the nitrogen-enriched state of the intake air. Furthermore, when the nitrogen-enriching section bypass determination section 110 determines that the intake air bypasses the nitrogen-enriching module 64 or where the nitrogen concentration determination section 112 determines that the intake air is not switched from the non-enriched state to the nitrogen-enriched state or determines that the nitrogen-enriched state does not at least continue for the specified time since switching of the intake air from the non-enriched state to the nitrogen-enriched state, the differential mechanism switching condition change section 114 does not change the determination vehicle speed V1 and the determination torque T1, at which the differential mechanism 16 is switched between the differential state and the non-differential state in the non-enriched state of the intake air, to the determination vehicle speed V2 and the determination torque T2, at which the differential mechanism 16 is switched between the differential state and the non-differential state in the nitrogen-enriched state of the intake air.

Here, the determination vehicle speed V2 is set to be higher than the determination vehicle speed V1 in the non-enriched state of the intake air within such a range where the first motor rotational speed Nml becomes at most equal to the first upper limit speed such that the first motor rotational speed Nml becomes at most equal to the second upper limit speed, at which the increase in the engagement shock generated in the switching brake B0 is suppressed, the engagement shock being generated at the time when the differential state at the fourth gear stage is switched to the fifth gear stage in the nitrogen-enriched state of the intake air. In the nitrogen-enriched state of the intake air, the determination torque T2 is set to be lower than the determination torque T1 in the non-enriched state of the intake air such that reaction torque of the first motor M1 does not exceed a torque limit of the first motor M1, the reaction torque corresponding to the engine output in the differential state of the differential mechanism 16. Here, the torque limit of the first motor M1 is a limit of the reaction torque that is defined based on rating of the first motor M1, for example. The determination vehicle speed V2 and the determination output torque T2 are set in advance such that the first motor rotational speed Nm1 becomes at most equal to the first upper limit speed after the operating state control section 113 changes the operation point of the engine 8 to the operation point P2, at which the engine speed Ne is located on the high-speed side of the operation point P1 of the engine 8 in the non-enriched state of the intake air, like the time before the operation point of the engine 8 is changed. Here, the determination vehicle speed V2 and the determination output torque T2 are determination values that are shown in FIG. 9 and are used to switch between the differential state and the non-differential state of the differential mechanism 16 in the nitrogen-enriched state of the intake air. In turn, the switching line is set such that the first motor rotational speed Nm1 becomes at most equal to the first upper limit speed before and after the change of the operation point of the engine 8 by the operating state control section 113. Note that each of the determination vehicle speeds V1, V2 is one example of a vehicle speed threshold of the present disclosure. Each of the determination torque T1, T2 is one example of a torque threshold of the present disclosure. In addition, in FIG. 9, a gear shift line that is used to switch between the fourth gear stage and the fifth gear stage in the nitrogen-enriched state of the intake air is set to be located on a high vehicle speed side of the gear shift line that is used to switch between the fourth gear stage and the fifth gear stage in the non-enriched state of the intake air such that the vehicle speed V on an upshift line thereof equals the determination vehicle speed V2.

When the nitrogen-enriching section bypass determination section 110 denies that the intake air bypasses the nitrogen-enriching module 64 and determines that the intake air is switched from the nitrogen-enriched state to the non-enriched state and that the non-enriched state at least continues for the specified time since switching from the nitrogen-enriched state to the non-enriched state, the differential mechanism switching condition change section 114 changes the determination vehicle speed V2 shown in FIG. 9 to the determination vehicle speed V1 shown in FIG. 7. Here, the determination vehicle speed V2 is a determination value that is used to switch between the differential state and the non-differential state of the differential mechanism 16 in the nitrogen-enriched state of the intake air. The determination vehicle speed V1 is a determination value that is used to switch between the differential state and the non-differential state of the differential mechanism 16 in the non-enriched state of the intake air. When the nitrogen-enriching section bypass determination section 110 denies that the intake air bypasses the nitrogen-enriching module 64 and determines that the intake air is switched from the nitrogen-enriched state to the non-enriched state and that the non-enriched state at least continues for the specified time since switching from the nitrogen-enriched state to the non-enriched state, the differential mechanism switching condition change section 114 changes the determination torque T2 shown in FIG. 9 to the determination torque T1 shown in FIG. 7. Here, the determination torque T2 is a determination value that is used to switch between the differential state and the non-differential state of the differential mechanism 16 in the nitrogen-enriched state of the intake air. The determination torque T1 is a determination value that is used to switch between the differential state and the non-differential state of the differential mechanism 16 in the non-enriched state of the intake air. When the nitrogen-enriching section bypass determination section 110 determines that the intake air bypasses the nitrogen-enriching module 64 or where the nitrogen concentration determination section 112 determines that the intake air is not switched from the nitrogen-enriched state to the non-enriched state or determines that the non -enriched state does not at least continue for the specified time since switching of the intake air from the nitrogen-enriched state to the non-enriched state, the differential mechanism switching condition change section 114 does not change the determination vehicle speed V2 and the determination torque T2 to the determination vehicle speed V1 and the determination torque T1. Here, the determination vehicle speed V2 and the determination torque T2 are determination values that are used to switch between the differential state and the non-differential state of the differential mechanism 16 in the nitrogen-enriched state of the intake air. Meanwhile, the determination vehicle speed V1 and the determination torque T1 are determination values that are used to switch between the differential state and the non-differential state of the differential mechanism 16 in the non-enriched state of the intake air.

In the cases where the intake air is switched from the non-enriched state to the nitrogen-enriched state and it is determined that the nitrogen-enriched state at least continues for the specified time since switching from the non-enriched state to the nitrogen-enriched state, the switching control section 108 switches between the differential state and the non-differential state of the differential mechanism 16 based on the switching diagram in FIG. 9 that is changed by the differential mechanism switching condition change section 114 from the switching diagram in FIG. 7 in which the intake air is in the non-enriched state. The speed-increasing side gear stage determination section 106 determines whether the gear stage to be shifted of the drive system 13 is the fifth gear stage from the switching diagram in FIG. 9 based on the travel state of the vehicle. When the speed-increasing side gear stage determination section 106 determines that the gear stage of the drive system 13 that should be shifted from the fourth gear stage in the differential state is the fifth gear stage, the switching control section 108 maintains the disengagement of the switching clutch C0 of the differential section 11, engages the switching brake B0, and thereby switches the differential mechanism 16 from the differential state to the non-differential state.

In the nitrogen-enriched state of the intake air, the speed-increasing side gear stage determination section 106 determines that the gear stage that should be shifted from the fourth gear stage in the differential state of the drive system 13 is the fifth gear stage based on the determination vehicle speed V2 that is higher than the determination vehicle speed V1 in the non-enriched state of the intake air. Thus, the first motor rotational speed Nm1 at a time when the gear shift state of the drive system 13 is switched from the fourth gear stage in the non-differential state to the fifth gear stage becomes at most equal to the second upper limit speed. In this way, the increase in the engagement shock of the switching brake B0 during switching from the differential state to the non-differential state of the differential mechanism 16 is suppressed. In addition, in the nitrogen-enriched state of the intake air, the differential state and the non-differential state of the differential mechanism 16 are switched by the actuation of the switching clutch C0 based on the determination torque T2 that is lower than the determination torque T1 in the non-enriched state of the intake air. Thus, in a high-output range of the vehicle where the reaction torque of the first motor M1 exceeds the torque limit, the differential mechanism 16 is switched from the differential state to the non-differential state. In this way, the first motor M1 can be actuated within the output limit range thereof.

The gear shift condition change section 116 of the stepped transmission control section 94 changes the gear shift line that is used to switch the gear stage of the automatic transmission mechanism 20 based on the determination result of the nitrogen concentration determination section 112. FIG. 10 includes a gear shift diagram of a case where the engine operation point in the nitrogen-enriched state of the intake air is changed to the high-speed side of the engine operation point in the non-enriched state of the intake air, shows the gear shift diagram with the switching diagram and the drive power source switching diagram in the non-enriched state of the intake air, and corresponds to FIG. 7. When the nitrogen-enriching section bypass determination section 110 denies that the intake air bypasses the nitrogen-enriching module 64 and determines that the intake air is switched from the non-enriched state to the nitrogen-enriched state and that the nitrogen-enriched state at least continues for the specified time since switching from the non-enriched state to the nitrogen-enriched state, the gear shift condition change section 116 changes the gear shift line shown in FIG. 7 to the gear shift line shown in FIG. 10. Here, the gear shift line shown in FIG. 7 is the gear shift line that is used to switch the gear stage of the automatic transmission mechanism 20 in the non-enriched state of the intake air. The gear shift line shown in FIG. 10 is a gear shift line in the nitrogen-enriched state of the intake air. The gear shift lines (an upshift line, a downshift line) that are used to switch between a first gear stage and a second gear stage in the nitrogen-enriched state of the intake air and that are shown in FIG. 10 are set to be on a high vehicle speed side and a low output torque side of the gear shift lines (the upshift line, the downshift line) that are used to switch between the first gear stage and the second gear stage in the non-enriched state of the intake air and that are shown in FIG. 7. In addition, the gear shift lines (an upshift line, a downshift line) that are used to switch between the second gear stage and a third gear stage in the nitrogen-enriched state of the intake air and that are shown in FIG. 10 are set to be on the high vehicle speed side and the low output torque side of the gear shift lines (the upshift line, the downshift line) that are used to switch between the second gear stage and the third gear stage in the non-enriched state of the intake air and that are shown in FIG. 7. Furthermore, the gear shift lines (an upshift line, a downshift line) that are used to switch between the third gear stage and the fourth gear stage in the nitrogen-enriched state of the intake air and that are shown in FIG. 10 are set to be on the high vehicle speed side and the low output torque side of the gear shift lines (the upshift line, the downshift line) that are used to switch between the third gear stage and the fourth gear stage in the non-enriched state of the intake air and that are shown in FIG. 7. Note that the gear shift lines (an upshift line, a downshift line) that are used to switch between the fourth gear stage and the fifth gear stage in the nitrogen-enriched state of the intake air and that are shown in FIG. 10 are set on the same speed as the gear shift lines (the upshift line, the downshift line) that are used to switch between the fourth gear stage and the fifth gear stage in the non-enriched state of the intake air and that are shown in FIG. 7. However, the gear shift state is switched between the fourth gear stage and the fifth gear stage in accordance with the switching diagram and the gear shift diagram in FIG. 9. When the nitrogen-enriching section bypass determination section 110 determines that the intake air bypasses the nitrogen-enriching module 64, determines that the intake air is not switched from the non-enriched state to the nitrogen-enriched state, or determines that the nitrogen-enriched state does not at least continue for the specified time since switching of the intake air from the non-enriched state to the nitrogen-enriched state, the gear shift condition change section 116 does not change the gear shift lines that are used to switch the gear stage of the automatic transmission mechanism 20 in the non-enriched state of the intake air to the gear shift lines that are used to switch the gear stage of the automatic transmission mechanism 20 in the nitrogen-enriched state of the intake air.

When the nitrogen-enriching section bypass determination section 110 denies that the intake air bypasses the nitrogen-enriching module 64 and determines that the intake air is switched from the nitrogen-enriched state to the non-enriched state and that the non-enriched state at least continues for the specified time since switching from the nitrogen-enriched state to the non-enriched state, the gear shift condition change section 116 changes the gear shift lines shown in FIG. 10 to the gear shift lines shown in FIG. 7. Here, the gear shift lines shown in FIG. 10 are the gear shift lines that are used to switch the gear stage of the automatic transmission mechanism 20 in the nitrogen-enriched state of the intake air. The gear shift lines shown in FIG. 7 are the gear shift lines in the non-enriched state of the intake air. In addition, when the nitrogen-enriching section bypass determination section 110 determines that the intake air bypasses the nitrogen-enriching module 64, determines that the intake air is not switched from the nitrogen-enriched state to the non-enriched state, or determines that the non-enriched state does not at least continue for the specified time since switching of the intake air from the nitrogen-enriched state to the non-enriched state, the gear shift condition change section 116 does not change the gear shift lines that are used to switch the gear stage of the automatic transmission mechanism 20 in the nitrogen-enriched state of the intake air to the gear shift lines that are used to switch the gear stage of the automatic transmission mechanism 20 in the non-enriched state of the intake air.

In the cases where it is determined that the intake air is switched from the non-enriched state to the nitrogen-enriched state and it is determined that the nitrogen-enriched state at least continues for the specified time since switching from the non-enriched state to the nitrogen-enriched state, the stepped transmission control section 94 switches the gear stage of the automatic transmission mechanism 20 based on the gear shift diagram in FIG. 10 that is changed by the gear shift condition change section 116 from the gear shift diagram in FIG. 7 in which the intake air is in the non-enriched state. Note that the switching diagram in FIG. 9 is shown with the gear shift diagram and the drive power source switching diagram in the non-enriched state of the intake air for a purpose of comparison as a matter of convenience and the gear shift diagram in FIG. 10 is shown with the switching diagram and the drive power source switching diagram in the non-enriched state of the intake air for a purpose of comparison as a matter of convenience. In this first embodiment, when the intake air is in the nitrogen-enriched state, the differential mechanism 16 or the gear stage of the automatic transmission mechanism 20 is not necessarily switched based on the relationship shown in either one of FIG. 9 and FIG. 10.

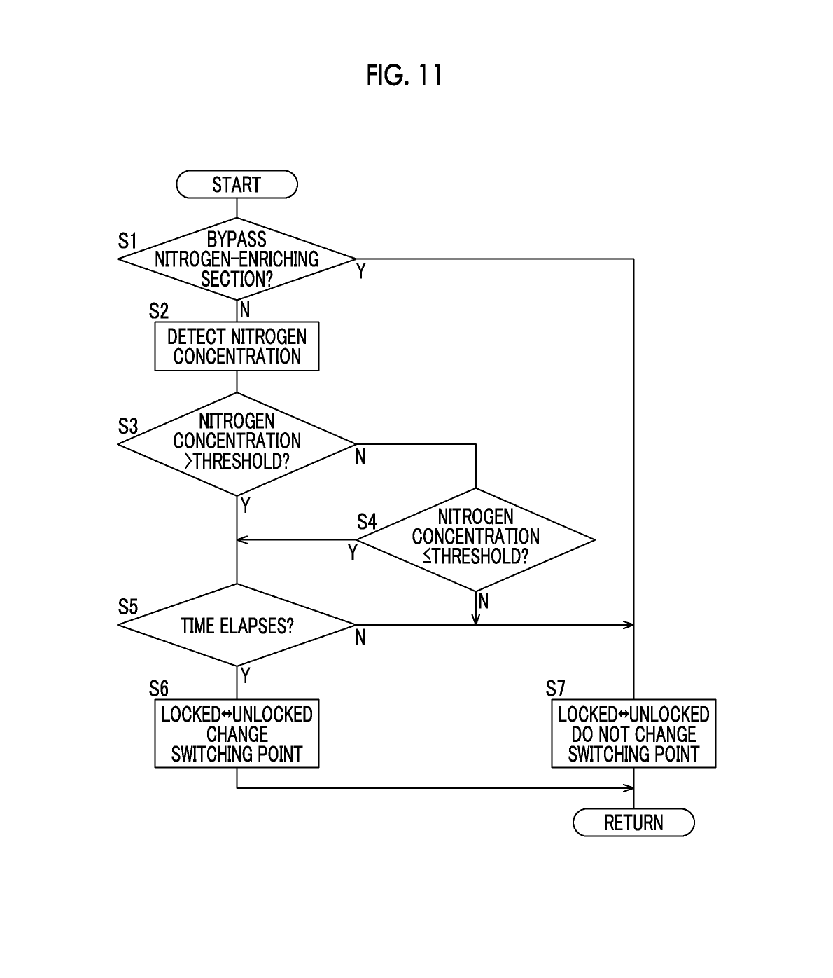

FIG. 11 is a flowchart that explains a main section of the control actuation of the electronic control unit 74. In FIG. 11, in step (hereinafter “step” will be omitted) S1 that corresponds to the function of the nitrogen-enriching section bypass determination section 110, it is determined whether the intake air bypasses the nitrogen-enriching module 64. If the determination in S1 is positive, S7 is executed. If the determination in S1 is negative, S2 is executed. In S2 that corresponds to the function of the nitrogen concentration determination section 112, the nitrogen concentration Cn of the intake air to be supplied to the engine 8 that is detected by the nitrogen concentration sensor 66 is obtained. In S3 that corresponds to the function of the nitrogen concentration determination section 112, it is determined whether the intake air that is supplied to the engine 8 is switched (changed) from the non-enriched state where the nitrogen concentration Cn thereof is at most equal to the specified concentration Cn0 to the nitrogen-enriched state where the nitrogen concentration Cn is higher than the specified concentration Cn0. If the determination in S3 is negative, S4 that corresponds to the function of the nitrogen concentration determination section 112 is executed, and it is determined whether the intake air is switched (changed) from the nitrogen-enriched state where the nitrogen concentration Cn thereof is higher than the specified concentration Cn0 to the non-enriched state where the nitrogen concentration Cn is at most equal to the specified concentration Cn0. If the determination in S3 is positive, or if the determination in S4 is positive, S5 that corresponds to the function of the nitrogen concentration determination section 112 is executed. In S5, it is determined whether the nitrogen-enriched state at least continues for the specified time since switching of the intake air from the non-enriched state to the nitrogen-enriched state, or it is determined whether the non-enriched state at least continues for the specified time since switching of the intake air from the nitrogen-enriched state to the non-enriched state. If the determination in S5 of whether the nitrogen-enriched state at least continues for the specified time since switching of the intake air from the non-enriched state to the nitrogen-enriched state is positive, in S6 that corresponds to the function of the differential mechanism switching condition change section 114, the determination vehicle speed and the determination torque of the switching line that is used to switch between the differential state (an unlocked state) and the non-differential state (a locked state) of the differential mechanism 16 are changed from the determination vehicle speed V1 in the non-enriched state and the determination torque T1 in the non-enriched state to the determination vehicle speed V2 in the nitrogen-enriched state that is set to be on the high vehicle speed side of the determination vehicle speed V1 and the determination torque T2 in the nitrogen-enriched state that is set on the low-torque side of the determination torque T1. If the determination in S5 of whether the non-enriched state at least continues for the specified time since switching of the intake air from the nitrogen-enriched state to the non-enriched state is positive, in S6, the determination vehicle speed and the determination torque of the switching line that is used to switch between the differential state (the unlocked state) and the non-differential state (the locked state) of the differential mechanism 16 are respectively changed from the determination vehicle speed V2 and the determination torque T2 in the nitrogen-enriched state to the determination vehicle speed V1 and the determination torque T1 in the non-enriched state. In this way, the differential mechanism 16 is switched between the differential state and the non-differential state based on the switching diagram that corresponds to the nitrogen-enriched state of the intake air or the non-enriched state of the intake air. After execution of S6, this flowchart is terminated. If the determination in S1 is positive, if the determination in S4 is negative, or if the determination in S5 is negative, in S7 that corresponds to the function of the differential mechanism switching condition change section 114, the determination vehicle speed and the determination torque that are used to switch between the differential state (the unlocked state) and the non-differential state (the locked state) of the differential mechanism 16 are not changed from those in one of the non-enriched state and the nitrogen-enriched state of the intake air to those in the other. After execution of S7, this flowchart is terminated.

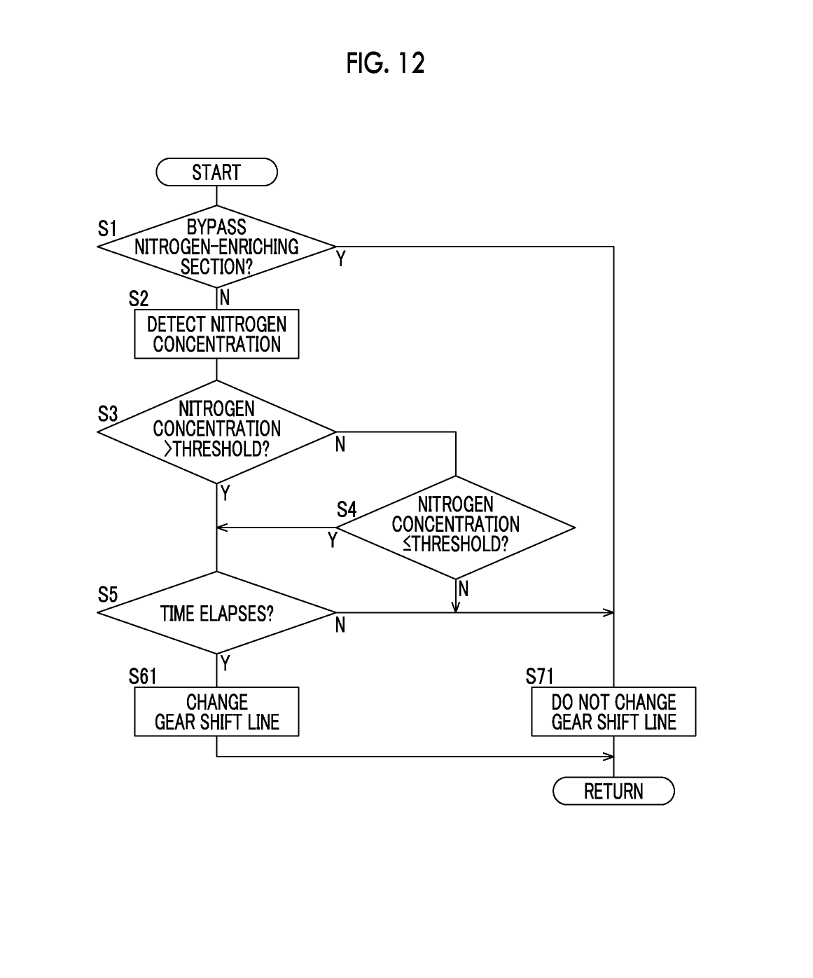

FIG. 12 is a flowchart that explains a main section of the control actuation of the electronic control unit 74. The control actuation of the electronic control unit 74 in FIG. 12 is the same as S1 to S5 of the control actuation of the electronic control unit 74 in FIG. 11 and is simultaneously executed in parallel with the control actuation of the electronic control unit 74 in FIG. 11. A description will hereinafter be made on a point that differs from the control actuation of the electronic control unit 74 in FIG. 11. S61 that corresponds to the function of the gear shift condition change section 116 is executed if the determination in S5 that corresponds to the function of the nitrogen concentration determination section 112 is positive. If the determination in S5 of whether the nitrogen-enriched state at least continues for the specified time since switching of the intake air from the non-enriched state to the nitrogen-enriched state is positive, in S61, the gear shift line that is used to switch the gear stage of the automatic transmission mechanism 20 is changed to the gear shift line that is set to be on the high vehicle speed side and the low-torque side of the gear shift line in the non-enriched state of the intake air. Alternatively, if the determination in S5 of whether the non-enriched state at least continues for the specified time since switching of the intake air from the nitrogen-enriched state to the non-enriched state is positive, in S61, the gear shift line that is used to switch the gear stage of the automatic transmission mechanism 20 is changed to the gear shift line that is set on a low vehicle speed side and a high-torque side of the gear shift line in the nitrogen-enriched state of the intake air. In this way, the gear stage of the automatic transmission mechanism 20 is switched based on the gear shift diagram that corresponds to the nitrogen-enriched state of the intake air or the non-enriched state of the intake air. After execution of S61, this flowchart is terminated. S71 that corresponds to the function of the gear shift condition change section 116 is executed if the determination in S1 is positive, if the determination in S4 is negative, or if the determination in S5 is negative. In S71, the gear shift line that is used to switch the gear stage of the automatic transmission mechanism 20 is not changed from that in one of the non-enriched state and the nitrogen-enriched state of the intake air to that in the other. After execution of S71, this flowchart is terminated.

As described above, according to the electronic control unit 74 of this first embodiment, the differential mechanism switching condition change section 114 of the hybrid control section 98 changes the determination vehicle speed and the determination torque of the switching line that is used to switch between the differential state and the non-differential state of the differential mechanism 16 based on the determination result by the nitrogen concentration determination section 112. In conjunction with the change of the engine operation point to the high-speed side in the nitrogen-enriched state of the intake air, the first motor rotational speed Nm1 becomes higher than that of the case where the intake air is in the non-enriched state in the differential state of the differential mechanism 16. Accordingly, corresponding to the first motor rotational speed Nm1, the determination vehicle speed and the determination torque that are used to switch between the differential state and the non-differential state of the differential mechanism 16 are respectively changed to the determination vehicle speed V2 that is on the high vehicle speed side of the determination vehicle speed V1 in the non-enriched state of the intake air and the determination torque T2 on the low-torque side of the determination torque T1 in the non-enriched state of the intake air. In this way, even when the intake air is in the nitrogen-enriched state, the differential mechanism 16 is appropriately switched between the differential state and the non-differential state. As a result, the increase in the engagement shock of the switching brake B0 during switching of the differential mechanism 16 from the differential state to the non-differential state is suppressed. In addition, the first motor M1 can be actuated within the output limit range thereof.

In addition, according to the electronic control unit 74 of this first embodiment, the stepped transmission control section 94 that switches the gear stage of the automatic transmission mechanism 20 is provided, and the automatic transmission mechanism 20 constitutes a portion of the power transmission route. The gear shift condition change section 116 of the stepped transmission control section 94 changes the gear shift line that is used to switch the gear stage of the automatic transmission mechanism 20 based on the determination result of the nitrogen concentration determination section 112. In conjunction with the change of the engine operation point to the high-speed side in the nitrogen-enriched state of the intake air, the first motor rotational speed Nm1 becomes higher than that of the case where the intake air is in the non-enriched state in the differential state of the differential mechanism 16. Accordingly, corresponding to the first motor rotational speed Nm1, the gear shift line that is used to switch the gear stage of the automatic transmission mechanism 20 is changed to the high vehicle speed side and the low-torque side of the gear shift line in the non-enriched state of the intake air. In this way, even when the intake air is in the nitrogen-enriched state, the appropriate gear stage is selected in the drive system 13. As a result, the automatic gear shifting within the output limit range of the first motor M1 becomes possible in the differential state of the differential mechanism 16.

Furthermore, according to the electronic control unit 74 of this first embodiment, the determination vehicle speed and the determination torque of the switching line that is used to switch between the differential state and the non-differential state of the differential mechanism 16 are set such that the first motor rotational speed Nml becomes at most equal to the first upper limit speed before and after the change of the operation point of the engine 8 by the operating state control section 113. Accordingly, the determination vehicle speed V2 and the determination output torque T2 of the switching line that is used to switch between the differential state and the non-differential state of the differential mechanism 16 are set such that the first motor rotational speed Nm1 becomes at most equal to the first upper limit speed not only before the change of the operation point of the engine 8 but also after the change thereof. Thus, the first motor M1 is prevented from falling out of an actuation enabling range thereof in the differential state of the differential mechanism 16, and the first motor M1 can be actuated appropriately.

Moreover, according to the electronic control unit 74 of this first embodiment, when the nitrogen concentration determination section 112 determines that the non-enriched state where the nitrogen concentration Cn of the intake air is at most equal to the specified concentration Cn0 is switched to the nitrogen-enriched state where the nitrogen concentration Cn is higher than the specified concentration Cn0 and that the nitrogen-enriched state at least continues for the specified time since switching from the non-enriched state to the nitrogen-enriched state or determines that the intake air is switched from the nitrogen-enriched state to the non-enriched state and that the non-enriched state thereof at least continues for the specified time since switching from the nitrogen-enriched state to the non-enriched state, the vehicle speed threshold and the torque threshold that are used to switch between the differential state and the non-differential state of the differential mechanism 16 and the gear shift line that switches the gear stage of the automatic transmission mechanism 20 are changed from those in one of the nitrogen-enriched state and the non-enriched state of the intake air to those in the other. Accordingly, even in a situation where switching between a state where the nitrogen concentration Cn of the intake air exceeds the specified concentration Cn0 and a state where the nitrogen concentration Cn of the intake air falls below the specified concentration Cn0 continues, that is, a situation where switching between the nitrogen-enriched state and the non-enriched state of the intake air continues, frequent changes of the vehicle speed threshold and the torque threshold that are used to switch between the differential state and the non-differential state of the differential mechanism 16 and a frequent change of the gear shift line that is used to switch the gear stage of the automatic transmission mechanism 20 are suppressed. Thus, frequent switching between the differential state and the non-differential state of the differential mechanism 16 is suppressed. Frequent switching of the gear stage of the automatic transmission mechanism 20 is also suppressed. In this way, the driver is prevented from feeling uncomfortable due to the above frequent switching.

Next, a description will be made on a second embodiment of the present disclosure. Note that, in the description of the second embodiment, substantially common portions with those of the first embodiment in terms of functions are denoted by the same reference numerals and a detailed description thereon will not be made.

In this second embodiment, the electronic control unit 74 is substantially common with that in the above-described first embodiment in terms of the function except for the operating state control section 113, the differential mechanism switching condition change section 114, and the gear shift condition change section 116 that have different control functions. A description will hereinafter be made on different points by using FIG. 13 to FIG. 15. FIG. 13 is a graph of one example of the optimum curve of the engine 8 that is represented by the relationship between the engine speed Ne and the engine torque Te of the engine 8. The optimum curve in the non-enriched state of the intake air that is suctioned to the engine 8 is represented by a solid line, and the optimum curve in the nitrogen-enriched state of the intake air that is suctioned to the engine 8 is represented by a broken line. In a portion of the optimum curve in the nitrogen-enriched state of the intake air, the engine speed Ne is shifted to a low-speed side and the engine torque Te is shifted to the high-torque side of the optimum curve in the non-enriched state of the intake air. From the engine optimum curve that is selected based on the determination result of the nitrogen concentration determination section 112, that is, based on whether the intake air is in the non-enriched state or the nitrogen-enriched state, the operating state control section 113 changes the engine operation point on the engine optimum curve before switching to be located on the selected engine optimum curve after switching based on the engine output that is required to satisfy the target output (the total target output, the requested drive power), for example. For example, when the engine output at the time when the intake air of the engine 8 is changed from the non-enriched state to the nitrogen-enriched state is not changed from the specified engine output, the operating state control section 113 changes the operation point of the engine 8 from the operation point P1 on the engine optimum curve in the non-enriched state to an operation point P2′ on the engine optimum curve in the nitrogen-enriched state in the arrow direction on the specified equal output curve L of the engine 8. At the operation point P2′ of the engine 8 in the nitrogen-enriched state of the intake air, the engine speed Ne is on the low-speed side and the engine torque Te is on the high-torque side of the operation point P1 of the engine 8 in the non-enriched state of the intake air at the specified engine output.

In the nitrogen-enriched state of the intake air, the operation point P1 of the engine 8 is changed to the operation point P2′ at which the engine speed Ne is located on the low-speed side. Thus, when the differential mechanism 16 is in the differential state, the first motor rotational speed Nm1 of the first motor M1 that is coupled to the differential section sun gear S0 becomes lower than the first motor rotational speed Nm1 at the time when the intake air of the engine 8 is in the non-enriched state. For this reason, in the nitrogen-enriched state of the intake air of the engine 8, the first motor M1 is possibly brought into a reversely powered state where the first motor M1 is powered in negative rotation, and is also possibly brought into a power circulating state where the electric power generated through regenerative electric power generation by the second motor M2 is supplied to the first motor M1 during the high-speed travel of the vehicle and the like, for example. In such a case, a transmission efficiency of the drive system 13 is possibly degraded in conjunction with an increase in the supplied electric power from the second motor M2 to the first motor M1.

FIG. 14 includes a switching diagram of a case where the engine operation point in the nitrogen-enriched state of the intake air is changed to the low-speed side of the engine operation point in the non-enriched state of the intake air, shows the switching diagram with the gear shift diagram and the drive power source switching diagram in the non-enriched state of the intake air, and corresponds to FIG. 7. When the nitrogen-enriching section bypass determination section 110 denies that the intake air bypasses the nitrogen-enriching module 64 and determines that the intake air is switched from the non-enriched state to the nitrogen-enriched state and that the nitrogen-enriched state at least continues for the specified time since switching from the non-enriched state to the nitrogen-enriched state, the differential mechanism switching condition change section 114 changes the determination vehicle speed V1 shown in FIG. 7 to a determination vehicle speed V2′ shown in FIG. 14. Here, the determination vehicle speed V1 is a determination value that is used to switch between the differential state and the non-differential state of the differential mechanism 16 in the non-enriched state of the intake air. In addition, the determination vehicle speed V2′ is a determination value that is used to switch between the differential state and the non-differential state of the differential mechanism 16 in the nitrogen-enriched state of the intake air. In addition, when the nitrogen-enriching section bypass determination section 110 denies that the intake air bypasses the nitrogen-enriching module 64 and determines that the intake air is switched from the non-enriched state to the nitrogen-enriched state and that the nitrogen-enriched state at least continues for the specified time since switching from the non-enriched state to the nitrogen-enriched state, the differential mechanism switching condition change section 114 changes the determination torque T1 shown in FIG. 7 to determination torque T2′ shown in FIG. 14. Here, the determination torque T1 is the determination value that is used to switch between the differential state and the non-differential state of the differential mechanism 16 in the non-enriched state of the intake air. In addition, the determination torque T2′ is a determination value that is used to switch between the differential state and the non-differential state of the differential mechanism 16 in the nitrogen-enriched state of the intake air. Furthermore, when the nitrogen-enriching section bypass determination section 110 determines that the intake air bypasses the nitrogen-enriching module 64, or the nitrogen concentration determination section 112 determines that the intake air is not switched from the non-enriched state to the nitrogen-enriched state or that the nitrogen-enriched state does not at least continue for the specified time since switching of the intake air from the non-enriched state to the nitrogen-enriched state, the differential mechanism switching condition change section 114 does not change the determination vehicle speed V1 and the determination torque T1 to the determination vehicle speed V2′ and the determination torque T2′. Here, the determination vehicle speed V1 and the determination torque T1 are the determination values that are used to switch between the differential state and the non-differential state of the differential mechanism 16 in the non-enriched state of the intake air. In addition, the determination vehicle speed V2′ and the determination torque T2′ are the determination values that are used to switch between the differential state and the non-differential state of the differential mechanism 16 in the nitrogen-enriched state of the intake air.

Here, the determination vehicle speed V2′ is set to be lower than the determination vehicle speed V1 in the non-enriched state of the intake air such that the first motor rotational speed Nm1 becomes at most equal to the second upper limit speed, at which the increase in the engagement shock generated in the switching brake B0 is suppressed, and that the first motor M1 is not brought into the reversely powered state when the fourth gear stage in the differential state is switched to the fifth gear stage in the nitrogen-enriched state of the intake air. Meanwhile, the determination torque T2′ is set to be higher than the determination torque T1 in the non-enriched state of the intake air within a range where the reaction torque of the first motor M1 that corresponds to the engine output in the differential state of the differential mechanism 16 does not exceed the torque limit of the first motor M1 in the nitrogen-enriched state of the intake air. Note that the determination vehicle speed V2′ is one example of the vehicle speed threshold of the present disclosure and the determination torque T2′ is one example of the torque threshold of the present disclosure. In addition, in FIG. 14, the gear shift lines that are used to switch between the fourth gear stage and the fifth gear stage in the nitrogen-enriched state of the intake air are set to be on the low vehicle speed side of the gear shift lines that are used to switch between the fourth gear stage and the fifth gear stage in the non-enriched state of the intake air such that an upshift line thereof equals the determination vehicle speed V2′.

When the nitrogen-enriching section bypass determination section 110 denies that the intake air bypasses the nitrogen-enriching module 64 and determines that the intake air is switched from the nitrogen-enriched state to the non-enriched state and that the non-enriched state at least continues for the specified time since switching from the nitrogen-enriched state to the non-enriched state, the differential mechanism switching condition change section 114 changes the determination vehicle speed V2′ shown in FIG. 14 to the determination vehicle speed V1 shown in FIG. 7. Here, the determination vehicle speed V2′ is the determination value that is used to switch between the differential state and the non-differential state of the differential mechanism 16 in the nitrogen-enriched state of the intake air. In addition, the determination vehicle speed V1 is the determination value that is used to switch between the differential state and the non-differential state of the differential mechanism 16 in the non-enriched state of the intake air. In addition, when the nitrogen-enriching section bypass determination section 110 denies that the intake air bypasses the nitrogen-enriching module 64 and determines that the intake air is switched from the nitrogen-enriched state to the non-enriched state and that the non-enriched state at least continues for the specified time since switching from the nitrogen-enriched state to the non-enriched state, the differential mechanism switching condition change section 114 changes the determination torque T2′ shown in FIG. 14 to the determination torque T1 shown in FIG. 7. Here, the determination torque T2′ is the determination value that is used to switch between the differential state and the non-differential state of the differential mechanism 16 in the nitrogen-enriched state of the intake air. In addition, the determination torque T1 is the determination value that is used to switch between the differential state and the non-differential state of the differential mechanism 16 in the non-enriched state of the intake air. Furthermore, when the nitrogen-enriching section bypass determination section 110 determines that the intake air bypasses the nitrogen-enriching module 64 or the nitrogen concentration determination section 112 determines that the intake air is not switched from the nitrogen-enriched state to the non-enriched state or determines that the non-enriched state does not at least continue for the specified time since switching of the intake air from the nitrogen-enriched state to the non-enriched state, the differential mechanism switching condition change section 114 does not change the determination vehicle speed V2′ and the determination torque T2′ to the determination vehicle speed V1 and the determination torque T1. Here, the determination vehicle speed V2′ and the determination torque T2′ are the determination values that are used to switch between the differential state and the non-differential state of the differential mechanism 16 in the nitrogen-enriched state of the intake air. In addition, the determination vehicle speed V1 and the determination torque T1 are determination values that are used to switch between the differential state and the non-differential state of the differential mechanism 16 in the non-enriched state of the intake air.

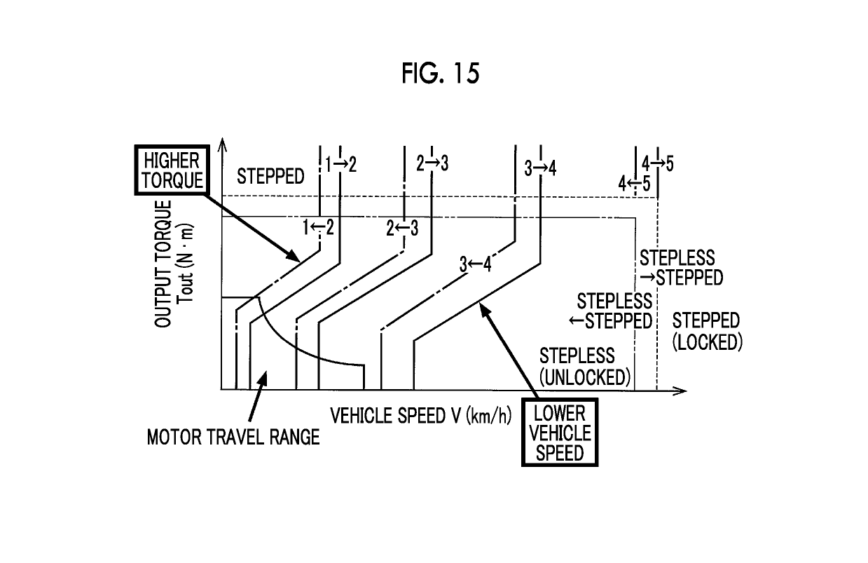

FIG. 15 includes a gear shift diagram of the case where the engine operation point in the nitrogen-enriched state of the intake air is changed to the low-speed side of the engine operation point in the non-enriched state of the intake air, shows the gear shift diagram with the switching diagram and the drive power source switching diagram in the non-enriched state of the intake air, and corresponds to FIG. 7. When the nitrogen-enriching section bypass determination section 110 denies that the intake air bypasses the nitrogen-enriching module 64 and determines that the intake air is switched from the non-enriched state to the nitrogen-enriched state and that the nitrogen-enriched state at least continues for the specified time since switching from the non-enriched state to the nitrogen-enriched state, the gear shift condition change section 116 changes the gear shift line shown in FIG. 7 to the gear shift line shown in FIG. 15. Here, the gear shift lines shown in FIG. 7 are the gear shift lines that are used to switch the gear stage of the automatic transmission mechanism 20 in the non-enriched state of the intake air. Meanwhile, the gear shift lines shown in FIG. 15 are gear shift lines in the nitrogen-enriched state of the intake air. The gear shift lines that are used to switch between the first gear stage and the second gear stage in the nitrogen-enriched state of the intake air and that are shown in FIG. 15 are set to be on the low vehicle speed side and the high output torque side of the gear shift lines that are used to switch between the first gear stage and the second gear stage in the non-enriched state of the intake air and that are shown in FIG. 7. In addition, the gear shift lines that are used to switch between the second gear stage and the third gear stage in the nitrogen-enriched state of the intake air and that are shown in FIG. 15 are set to be on the low vehicle speed side and the high output torque side of the gear shift lines that are used to switch between the second gear stage and the third gear stage in the non-enriched state of the intake air and that are shown in FIG. 7. Furthermore, the gear shift lines that are used to switch between the third gear stage and the fourth gear stage in the nitrogen-enriched state of the intake air and that are shown in FIG. 15 are set to be on the low vehicle speed side and the high output torque side of the gear shift lines that are used to switch between the third gear stage and the fourth gear stage in the non-enriched state of the intake air and that are shown in FIG. 7. Note that the gear shift lines that are used to switch between the fourth gear stage and the fifth gear stage in the nitrogen-enriched state of the intake air and that are shown in FIG. 15 are set on the same speed as the gear shift lines that are used to switch between the fourth gear stage and the fifth gear stage in the non-enriched state of the intake air and that are shown in FIG. 7. However, the gear shift state is switched between the fourth gear stage and the fifth gear stage in accordance with the switching diagram and the gear shift diagram in FIG. 14. When the nitrogen-enriching section bypass determination section 110 determines that the intake air bypasses the nitrogen-enriching module 64 or the nitrogen concentration determination section 112 determines that the intake air is not switched from the non-enriched state to the nitrogen-enriched state or that the nitrogen-enriched state does not at least continue for the specified time since switching of the intake air from the non-enriched state to the nitrogen-enriched state, the gear shift condition change section 116 does not change the gear shift lines that are used to switch the gear stage of the automatic transmission mechanism 20 in the non-enriched state of the intake air to the gear shift lines that are used to switch the gear stage of the automatic transmission mechanism 20 in the nitrogen-enriched state of the intake air.

When the nitrogen-enriching section bypass determination section 110 denies that the intake air bypasses the nitrogen-enriching module 64 and the nitrogen concentration determination section 112 determines that the intake air is switched from the nitrogen-enriched state to the non-enriched state and that the non-enriched state at least continues for the specified time since switching from the nitrogen-enriched state to the non-enriched state, the gear shift condition change section 116 changes the gear shift lines shown in FIG. 15 to the gear shift lines shown in FIG. 7. Here, the gear shift lines shown in FIG. 15 are the gear shift lines that are used to switch the gear stage of the automatic transmission mechanism 20 in the nitrogen-enriched state of the intake air. Meanwhile, the gear shift lines shown in FIG. 7 are the gear shift lines in the non-enriched state of the intake air. When the nitrogen-enriching section bypass determination section 110 determines that the intake air bypasses the nitrogen-enriching module 64 or the nitrogen concentration determination section 112 determines that the intake air is not switched from the nitrogen-enriched state to the non-enriched state or that the non-enriched state does not at least continue for the specified time since switching of the intake air from the nitrogen-enriched state to the non-enriched state, the gear shift condition change section 116 does not change the gear shift lines that are used to switch the gear stage of the automatic transmission mechanism 20 in the nitrogen-enriched state of the intake air to the gear shift lines that are used to switch the gear stage of the automatic transmission mechanism 20 in the non-enriched state of the intake air.

In the gear shift lines that are used to switch the gear stage of the automatic transmission mechanism 20 in the nitrogen-enriched state of the intake air, that are shown in FIG. 15, and that are after the operation point of the engine 8 is changed to be on the low-speed side of the operation point P1 of the engine 8 in the non-enriched state of the intake air by the operating state control section 113, the vehicle speed V and the output torque thereof are set in advance such that the first motor rotational speed Nm1 becomes at most equal to the first upper limit speed, at which the first motor M1 can be actuated within the output limit range, in the differential state of the differential mechanism 16, like the time before the operation point of the engine 8 is changed. In addition, the gear shift lines are set to be on the low vehicle speed side of the gear shift lines in the non-enriched state of the intake air so as to suppress the first motor M1 from being brought into the reversely powered state.

As described above, similar effects as those in the above-described first embodiment are obtained in this second embodiment. In this second embodiment, in the nitrogen-enriched state of the intake air, the speed-increasing side gear stage determination section 106 determines that the gear stage of the drive system 13 that should be shifted from the fourth gear stage in the differential state is the fifth gear stage based on the determination vehicle speed V2′ that is lower than the determination vehicle speed V1 in the non-enriched state of the intake air. Accordingly, when the gear shift state of the drive system 13 is switched from the fourth gear stage in the non-differential state to the fifth gear stage, the first motor rotational speed Nm1 becomes at most equal to the second upper limit speed, and the first motor M1 is suppressed from being brought into the reversely powered state. In this way, the increase in the engagement shock of the switching brake B0 during switching from the differential state to the non-differential state of the differential mechanism 16 is suppressed, and degradation of the transmission efficiency of the drive system 13 is suppressed. In addition, in the nitrogen-enriched state of the intake air, the differential state and the non-differential state of the differential mechanism 16 are switched based on the determination torque T2′ that is higher than the determination torque T1 in the non-enriched state of the intake air. Thus, within the range where the reaction torque of the first motor M1 does not exceed the torque limit, the actuation range of the first motor M1 is expanded in such a manner as to correspond to the high-output range of the vehicle. In this way, a range of the differential state of the differential mechanism 16 within which the engine 8 can be actuated along the optimum curve can be expanded to the high output torque side when compared to that in the non-enriched state of the intake air. Thus, the efficiency of the engine 8 can be improved.

In addition, in this second embodiment, switching of the gear stages between the first gear stage and the second gear stage, between the second gear stage and the third gear stage, and between the third gear stage and the fourth gear stage is executed on the low vehicle speed side in the nitrogen-enriched state of the intake air in comparison with switching thereof in the non-enriched state of the intake air. Thus, the first motor M1 is suppressed from being brought into the reversely powered state in the differential state of the differential mechanism 16, and the degradation of the transmission efficiency of the drive system 13 is suppressed.

The detailed description has been made so far on the present disclosure with reference to the table and the drawings. The present disclosure can further be implemented in another aspect, and various changes can be added thereto within the scope that does not depart from the gist thereof.

For example, in the above-described first embodiment and second embodiment, in the nitrogen-enriched state of the intake air, the determination vehicle speed V1 and the determination output torque T1 of the switching line that is used to switch between the differential state and the non-differential state of the differential mechanism 16 in the non-enriched state of the intake air are changed. However, the present disclosure is not limited thereto. Either one of the determination vehicle speed V1 and the determination output torque T1 of the switching line may be changed.

In addition, in the above-described first embodiment and second embodiment, in the nitrogen-enriched state of the intake air, the gear shift line that is used to switch the gear stage of the automatic transmission mechanism 20 in the non-enriched state of the intake air is changed to the high vehicle speed side and the low-torque side or to the low vehicle speed side and the high-torque side. However, the present disclosure is not limited thereto. Either one of the vehicle speed V and the output torque Tout of the gear shift line may be changed.

Furthermore, in the above-described first embodiment and second embodiment, in the nitrogen-enriched state of the intake air, the switching line and the gear shift line are changed from those in the non-enriched state of the intake air. However, the present disclosure is not limited thereto. When the first motor M1 is appropriately controlled by the change of the switching line, the gear shift line may not necessarily be changed.

In the above-described first embodiment, the differential section 11 includes the switching brake B0 and the switching clutch C0. However, the present disclosure is not limited thereto. The differential section 11 may be a drive system that does not include the switching clutch C0. Even when the electronic control unit 74 is applied to the drive system that is configured just as described, the differential state and the non-differential state of the differential mechanism is appropriately switched when the determination vehicle speed and the determination torque of the switching line that is used to switch between the differential state and the non-differential state of the differential mechanism in the nitrogen-enriched state of the intake air are changed from those of the switching line in the non-enriched state of the intake air. In addition, in the drive system that does not include the above switching clutch C0, the gear shift line that is used to switch the gear stage of the automatic transmission mechanism in the nitrogen-enriched state of the intake air is changed from the gear shift line in the non-enriched state of the intake air. Thus, the gear stage of the automatic transmission mechanism is appropriately switched.

In the above-described first embodiment, when the nitrogen concentration determination section 112 determines that the intake air is switched from the non-enriched state where the nitrogen concentration Cn thereof is at most equal to the specified concentration Cn0 to the nitrogen-enriched state where the nitrogen concentration Cn thereof is higher than the specified concentration Cn0 and that the nitrogen-enriched state continues for the specified time since switching from the non-enriched state to the nitrogen-enriched state, or when the nitrogen concentration determination section 112 determines that the intake air is switched from the nitrogen-enriched state to the non-enriched state and that the non-enriched state continues for the specified time since switching from the nitrogen-enriched state to the non-enriched state, each of the switching line that is used to switch between the differential state and the non-differential state of the differential mechanism 16 and the gear shift line that is used to switch the gear stage of the automatic transmission mechanism 20 is changed from that in one of the nitrogen-enriched state and the non-enriched state of the intake air to that in the other. However, the present disclosure is not limited thereto. For example, the switching line and the gear shift line may be changed when such a condition is satisfied that, when the intake air is switched from the non-enriched state to the nitrogen-enriched state or from the nitrogen-enriched state to the non-enriched state, the switched state at least continues for the specified time.

In the above-described first embodiment, when the nitrogen concentration determination section 112 determines that the intake air is brought into the state where the nitrogen concentration Cn thereof becomes higher than the specified concentration Cn0 and that the state at least continues for the specified time, or when the nitrogen concentration determination section 112 determines that the intake air is brought into the state where the nitrogen concentration Cn thereof becomes at most equal to the specified concentration Cn0 and that the state at least continues for the specified time, each of the switching line and the gear shift line is changed from that in one of the nitrogen-enriched state and the non-enriched state of the intake air to that in the other. However, the present disclosure is not limited thereto. For example, it may be configured that the above condition is only necessary for the change of the switching line and that the gear shift line is changed by switching of the intake air from the nitrogen-enriched state to the non-enriched state or switching of the intake air from the non-enriched state to the nitrogen-enriched state.

In the above-described first embodiment, when the nitrogen concentration determination section 112 determines that the intake air is brought into the state where the nitrogen concentration Cn thereof becomes higher than the specified concentration Cn0 and that the state at least continues for the specified time, or when the nitrogen concentration determination section 112 determines that the intake air is brought into the state where the nitrogen concentration Cn thereof becomes at most equal to the specified concentration Cn0 and that the state at least continues for the specified time, the switching line that is used to switch between the differential state and the non-differential state of the differential mechanism 16 and the gear shift line that is used to switch the gear stage of the automatic transmission mechanism 20 are changed. However, the present disclosure is not limited thereto. For example, when the hybrid control section 98 and the stepped transmission control section 94 determine that the signal supplied by the nitrogen concentration determination section 112 and indicative of the non-enriched state of the intake air where the nitrogen concentration Cn thereof is at most equal to the specified concentration Cn0 is switched to the signal indicative of the nitrogen-enriched state of the intake air where the nitrogen concentration Cn thereof is higher than the specified concentration Cn0 and that the signal indicative of the nitrogen-enriched state is continuously obtained at least for the specified time, or when the hybrid control section 98 and the stepped transmission control section 94 determine that the signal indicative of the nitrogen-enriched state of the intake air is switched to the signal indicative of the non-enriched state of the intake air and that the signal indicative of the non-enriched state is continuously obtained at least for the specified time, it may be configured that the differential state and the non-differential state of the differential mechanism 16 are switched or the gear stage of the automatic transmission mechanism 20 is switched. Even with the configuration just as described, when the state where the nitrogen concentration Cn of the intake air is higher than the specified concentration Cn0 and the state where the nitrogen concentration Cn of the intake air is at most equal to the specified concentration Cn0 are frequently switched, frequent switching between the differential state and the non-differential state of the differential mechanism 16 or frequent switching of the gear stage of the automatic transmission mechanism 20 is suppressed.

In the drive system 13 of this second embodiment, the nitrogen-enriching module 64 that is provided in the engine 8 brings the intake air into the nitrogen-enriched state. However, the present disclosure is not limited thereto. It may be configured that an exhaust recirculation route and an exhaust recirculation valve are provided instead of the nitrogen-enriching module 64, so as to bring the intake air into the nitrogen-enriched state, the exhaust recirculation route being formed by connecting the intake passage 46 and the exhaust passage 42 and introducing some of the exhaust gas containing nitrogen oxide and the like into the intake passage 46 again, and the exhaust recirculation valve adjusting the amount of the exhaust gas introduced into the intake passage 46. Even when the switching line and the gear shift line are changed in accordance with an increase in the nitrogen concentration Cn of the intake air by so-called exhaust gas recirculation (EGR), just as described, similar effects to those of the first embodiment or the second embodiment are obtained.

In addition, in this second embodiment, the nitrogen concentration determination section 112 determines whether the nitrogen concentration Cn of the intake air on the downstream side of the nitrogen-enriching module 64, which is detected by the nitrogen concentration sensor 66, is higher than the specified concentration Cn0. However, the present disclosure is not limited thereto. The nitrogen concentration Cn of the intake air may be estimated from a switching command to the actuator that drives the bypass valve 70 and operates the bypass valve 70 to the opened side or the closed side. Alternatively, the nitrogen concentration Cn of the intake air may be estimated from the supercharging pressure Pcmout of the intake air that is detected by the nitrogen-enriching section air pressure sensor provided in the nitrogen-enriching module 64 and that is supplied to the nitrogen-enriching module 64.

Note that what has been described above is merely one embodiment. Although not illustrated, the present disclosure can be implemented in aspects in which various changes and/or improvements are made within the scope that does not depart from the gist thereof based on knowledge of persons skilled in the art.

What is claimed is:

1. A vehicle drive system, comprising:
a nitrogen concentration changing device configured to change an amount of nitrogen contained in intake air of an internal combustion engine;
an electric differential section that has:
a differential mechanism coupled between the internal combustion engine and a drive wheel;
a motor coupled to one of plural rotation elements of the differential mechanism;
an engaging element configured to swithch the differential mechanism to either one of a differential state and a non-differential state; and
an electronic control unit configured to:
i) determine nitrogen concentration contained in the intake air to the internal combustion engine;
ii) change an operation point of the internal combustion engine based on a determination result of the nitrogen concentration;
iii) control the engaging element that switches the differential mechanism to either one of the differential state and the non-differential state; and
iv) change at least one of a vehicle speed threshold or a torque threshold that are used to switch between the differential state and the non-differential state of the differential mechanism based on the determination result of the nitrogen concentration.

2. The vehicle drive system according to claim 1, wherein:
the electronic control unit is configured to:
(i) switch a gear stage of an automatic transmission mechanism that constitutes a part of a power transmission route; and
(ii) change a gear shift line that is used to switch the gear stage of the automatic transmission mechanism based on the determination result of the nitrogen concentration.

3. The vehicle drive system according to claim 1, wherein
the electronic control unit is configured to set at least one of the vehicle speed threshold and the torque threshold, which are used to switch between the differential state and the non-differential state of the differential mechanism, such that a rotational speed of the motor becomes equal to or smaller than a specified value before and after a change of the operation point of the internal combustion engine.

4. The vehicle drive system according to claim 1, wherein
the electronic control unit is configured to set a gear shift line that is used to switch a gear stage of an automatic transmission mechanism, such that a rotational speed of the motor becomes equal to or smaller than a specified value before and after a change of the operation point of the internal combustion engine.

5. The vehicle drive system according to claim 1, wherein
the electronic control unit is configured to change at least one of the vehicle speed threshold and the torque threshold, which are used to switch between the differential state and the non-differential state of the differential mechanism, when the electronic control unit determines that a time during which the nitrogen concentration becomes higher than a specified value or a time during which the nitrogen concentration becomes equal to or smaller than the specified value at least continues for a specified time.

6. The vehicle drive system according to claim 1, wherein
the electronic control unit is configured to change a gear shift line that is used to switch a gear stage of an automatic transmission mechanism when the electronic control unit determines that a time during which the nitrogen concentration becomes higher than a specified value or a time during which the nitrogen concentration becomes equal to or smaller than the specified value at least continues for a specified time.
